(19) United States
(12) Patent Application Publication
(10) Pub. No.: US 2024/0294752 A1
(43) Pub. Date: Sep. 5, 2024

(54) POLYAMIDE COMPOSITION, A PROCESS FOR PREPARING THE SAME, ITS APPLICATION AND AN ARTICLE MADE THEREFROM

(71) Applicant: BASF SE, Ludwigshafen am Rhein (DE)

(72) Inventors: Hang LU, Shanghai (CN); Lin CHEN, Shanghai (CN); Lu Ping Zhao, Shanghai (CN)

(21) Appl. No.: 18/573,827

(22) PCT Filed: Jul. 1, 2022
(86) PCT No.: PCT/EP22/68306

§ 371 Date: Dec. 22, 2023

(30) Foreign Application Priority Data
Jul. 14, 2021 (CN) PC/CN2021/106187

(51) Int. Cl. C08L 77/02; C08K 7/28; C08K 9/00; C08L 9/06; C08L 51/04; C08L 51/06; C08L 77/06

(52) U.S. Cl. CPC C08L 77/02; C08K 7/28; C08K 9/00; C08L 9/06; C08L 51/04; C08L 51/06; C08L 77/06; C08K 2201/003; C08L 2203/20; C08L 2203/30; C08L 2205/025

(57) ABSTRACT

Described herein is a polyamide composition, which includes at least one polyamide, hollow glass bubbles, and impact modifier, where the impact modifier includes a combination of grafted impact modifier and non-grafted impact modifier. The polyamide composition has improved the mechanical properties of a molded body made from the composition, especially the toughness, and a balance in stiffness and toughness without sacrificing the weight-decreasing effects at the same time.

### TECHNICAL FIELD

The present invention relates to a polyamide composition, especially relates to a polyamide composition with low density and good toughness. The invention also relates to a process for preparing the composition, its application and an article made from the composition.

### BACKGROUND ART

Polyamides, commonly known as nylon resins, are well known for possessing an outstanding combination of strength, toughness and resistance to solvents and accordingly nylon resins have found increasing use in automotive and electrical applications.

Due to environmental protection and operating cost consideration, more and more spotlights are focusing on the fuel-saving that trigger the replacement of heavier metal with the lighter material in the automotive industry. Also, as miniaturization and portability gradually become the predominant target and major concern for manufacturers and consumers, light-weight materials have become a paramount objective in hand-hold electronics field.

Polyamide composition comprising hollow glass bubbles is disclosed to be used as such light-weight materials. For example, polyamide composition including at least one polyamide, hollow glass bubbles and reinforcing fibers and an application of the polyamide composition in the light-weight parts, especially in the light-weight parts for vehicles have been disclosed. When the hollow glass bubbles are added into the polyamide composition, the material can be made lighter, but on the other hand, there is a tendency for mechanical properties such as specific tensile strength, specific flexural strength, and the like of an obtained composition or of a molded body made from this composition to be inferior. There have been attempts made to treat surfaces of the hollow glass bubbles with a coupling agent, however the mechanical properties required in the fields of electronic components and automotive components are still not desirable with such surface treatments, for example, WO2012/151178A discloses a combination of polyamide 6,6 and hollow glass microspheres surface treated with a silane coupling agent; however the defect in this reference is the tensile strain at break is scarified to reduce the density.

Accordingly, in addition to the surface treatment to the hollow glass bubbles, there are continuous needs in the above fields to improve the mechanical properties of the molded body made from the composition, especially the toughness and to keep a balance in stiffness and toughness, without sacrificing the weight-decreasing effects at the same time.

### SUMMARY OF INVENTION

The inventors of the present invention have made attempts to solve the above problem and found that a combination of a polyamide and impact modifier can enhance the elongation of low density polyamide material, and at the same time, the stiffness of the resulting material is still acceptable. Also, it has been found that the polyamide and the impact modifier have contributory effects to reduce the density of polyamide composition.

In the first aspect of the present invention, it is provided a polyamide composition, which comprises at least one polyamide, hollow glass bubbles, and impact modifier, characterized in that the at least one polyamide is selected from a polyamide having a repeating unit of Formula (I) and a polyamide having a repeating unit of Formula (II), and the impact modifier includes a combination of grafted impact modifier and non-grafted impact modifier:

[symbol]

NH—R¹—CO [symbol] Formula (I);

[symbol]

NH—R²—NH—CO—R³—CO [symbol] Formula (II);
R¹ independently equals to or differs from each other, is a divalent hydrocarbon group, preferably an alkylene group or a cycloalkylene group, having from 8 to 40 carbon atoms;
R² independently equals to or differs from each other, is a divalent hydrocarbon group, preferably an alkylene group or a cycloalkylene group, having from 4 to 40 carbon atoms;
R³ independently equals to or differs from each other, is a divalent hydrocarbon group, preferably an alkylene group or a cycloalkylene group, having from 7 to 38 carbon atoms.

In the second aspect of the present invention, it is provided a polyamide composition, which comprises a combination of at least two polyamides, hollow glass bubbles, and impact modifier, characterized in that one of the at least two polyamides has a repeating unit of Formula (V), the other one of the at least two polyamides has a repeating unit of Formula (VI) or Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is a divalent hydrocarbon group, preferably an alkylene group or a cycloalkylene group, having from 4 to 6 carbon atoms;
R⁸ independently equals to or differs from each other, is a divalent hydrocarbon group, preferably an alkylene group or a cycloalkylene group, having from 7 to 10 carbon atoms;
R⁹ independently equals to or differs from each other, is a divalent hydrocarbon group, preferably an alkylene group or a cycloalkylene group, having from 10 to 39 carbon atoms;
R¹⁰ independently, equals to or differs from each other, is a divalent hydrocarbon group, preferably an alkylene group or a cycloalkylene group, having from 6 to 40 carbon atoms;
R¹¹ independently, equals to or differs from each other, is a divalent hydrocarbon group, preferably an alkylene group or a cycloalkylene group, having from 8 to 38 carbon atoms;
the total number of carbon atom in Formula (VII) is more than 18.

Further, the present invention provides a manufacturing process of a polyamide composition, comprising combining all components of the polyamide composition.

Still further, the present invention provides an article prepared from the above-mentioned polyamide composition.

According to the present invention, the article prepared from the above polyamide composition has achieved both lower density and good toughness, especially higher tensile strain at break.

Still further, the present invention provides use of the polyamide composition in the light-weight parts, especially in the light-weight parts for automobile components and for mobile electronic devices.

### DETAILED DESCRIPTION OF THE INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

As used herein, the term “about” refers to a range of numbers that a person of skill in the art would consider equivalent to the recited value in the context of achieving the same function or result.

As used herein, the term “comprising one” should be understood as being synonymous with the term “comprising at least one”, and “between” should be understood as being inclusive of the limits.

Unless otherwise identified, all percentages (%) are “percent by weight”.

The radical definitions or elucidations given above in general terms or within areas of preference apply to the end products and correspondingly to the starting materials and intermediates. These radical definitions can be combined with one another as desired, i.e. including combinations between the general definition and/or the respective ranges of preference and/or the embodiments.

All the embodiments and the preferred embodiments disclosed herein can be combined as desired, which are also regarded as being covered within the scope of the present invention.

As used herein, the term “PA” refers to polyamide. The term “PA*/PA**” refers to copolymer of PA* and PA**.

The below description to the polyamide is related to the first aspect of the present invention.

According to the first aspect of the invention, a polyamide composition, comprising at least one polyamide, hollow glass bubbles, and impact modifier is provided, wherein the at least one polyamide is selected from a polyamide having a repeating unit of Formula (I) and a polyamide having a repeating unit of Formula (II):

[symbol]

NH—R¹—CO [symbol] Formula (I);

[symbol]

NH—R²—NH—CO—R³—CO [symbol] Formula (II);
R¹ equals to or differs from each other, is a divalent hydrocarbon group having from 8 to 40 carbon atoms, preferably from 8 to 19 carbon atoms, more preferably from 8 to 12 carbon atoms;
R² equals to or differs from each other, is a divalent hydrocarbon group having from 4 to 40 carbon atoms, preferably from 4 to 24 carbon atoms, more preferably from 4 to 18, most preferably from 8 to 16, for example having 4, 6, 8, 9, 10, 11, 12, 13 and/or 14 carbon atoms;
R³ equals to or differs from each other, is a divalent hydrocarbon group having from 7 to 38 carbon atoms, preferably from 7 to 36 carbon atoms, more preferably from 8 to 36 carbon atoms, furthermore preferably from 8 to 20 and 34 carbon atoms, most preferably having 7, 8, 9, 10, 11, 12, 13, 14, 15, 16, 17, 18 and/or 34 carbon atoms.

The divalent hydrocarbon group of R¹, R² or R³ is preferably alkylene group and/or cycloalkylene group, respectively, more preferably is alkylene group.

The above polyamide in the first aspect of the present invention can be typically derived from at least one aliphatic monomer which is selected from the group consisting of (a) lactam having 9 or more carbon atoms, (b) amino acid having 9 or more carbon atoms, (c) aliphatic dicarboxylic acid having from 9 to 40 carbon atoms and aliphatic diamine having from 4 to 40 carbon atoms; (d) dicarboxylic acid chloride having from 9 to 40 carbon atoms and aliphatic diamine having from 4 to 40 carbon atoms.

The lactam having 9 or more carbon atoms preferably has from 9 to 20 carbon atoms, more preferably has 9, 10, 11, 12 or 13 carbon atoms. The lactam having 9 or more carbon atoms could be any of laurolactam, undecanolactam, decanelactam, and mixtures thereof.

The amino acid having 9 or more carbon atoms preferably has from 9 to 20 carbon atoms, more preferably has 9, 10, 11, 12 or 13 carbon atoms. The amino acid having 9 or more carbon atoms could be any of 9-aminononanoic acid, 10-aminodecanoic acid, 11-aminoundecanoic acid, 12-aminododecanoic acid, and mixtures thereof.

The aliphatic dicarboxylic acid having from 9 to 40 carbon atoms preferably has from 9 to 20 and 36 carbon atoms, more preferably has 9, 10, 11, 12, 13, 14, 15, 16, 17, 18 and/or 36 carbon atoms. The aliphatic dicarboxylic acid having from 9 to 40 carbon atoms could be any of azelaic acid, sebacic acid, undecanedioic acid, dodecandioic, tridecanedioic acid, tetradecandioic acid, pentadecanoic acid, hexadecanedioic acid, octadecandioic acid, dimer acid having 36 carbon atoms, and mixtures thereof.

The aliphatic diamine having from 4 to 40 carbon atoms preferably has from 4 to 24 carbon atoms, more preferably has from 4 to 18 carbon atoms, most preferably has 4, 6, 8, 9, 10, 11, 12, 13 and 14 carbon atoms. The aliphatic diamine having from 4 to 40 carbon atoms could be linear aliphatic diamine or branched aliphatic diamine, preferably is any of 1,4-diaminobutane, 1,5-diaminopentane, 1,6-diaminohexane, 1,7-diaminoheptane, 1,8-diamino-octane, 1,9-diaminononane, 1,10-diaminodecane, 1,11-diaminoundecane, 1,12-diaminododecane, 1,13-tridecanediamine, 1,14-tetradecanediamine, 1,16-hexadecanediamine, 1,18-octadecanediamine, 1,20-eicosanediamine, 1,22-docosanediamine, 2-methyl-1,5-pentane diamine, 3-methyl-1,5-pentane diamine, 1,6-diamino-2,5-dimethylhexane, 1,6-diamino-2,4-dimethylhexane, 1,6-diamino-3,3-dimethylhexane, 1,6-diamino-2,2-dimethylhexane, 2,2,4-trimethylhexane-1,6-diamine, 2,4,4-trimethylhexane-1,6-diamine, 2,3-dimethylheptane-1,7-diamine, 2,4-dimethylheptane-1,7-diamine, 2,5-dimethylheptane-1,7-diamine, 2,2-dimethylheptane-1,7-diamine, 2-methyl-1,8-octanediamine, 1,3-dimethyloctane-1,8-diamine, 1,4-dimethyloctane-1,8-diamine, 2,4-dimethyloctane-1,8-diamine, 3,4-dimethyloctane-1,8-diamine, 4,5-dimethyloctane-1,8-diamine, 2,2-dimethyloctane-1,8-diamine, 3,3-dimethyloctane-1,8-diamine, 4,4-dimethyloctane-1,8-diamine, 2,4-diethylhexane-1,6-diamine, 5-methylnonane-1,9-diamine, and mixtures thereof.

The aliphatic dicarboxylic acid chloride having from 9 to 40 carbon atoms preferably has from 9 to 20 carbon atoms, more preferably has 9, 10, 11, 12, 13, 14, 15, 16, 17, 18 carbon atoms. The dicarboxylic acid chloride having from 9 to 40 carbon atoms could be any of azelaoyl chloride, sebacoyl chloride, undecanedioyl dichloride, and mixtures thereof.

The above polyamide having a repeating unit of Formula (I) and the polyamide having a repeating unit of Formula (II) could preferably be at least one selected from the group consisting of PA9, PA10, PA11, PA12, PA13, PA6,9, PA4, 10, PA5, 10, PA5, 13, PA5, 15, PA6, 10, PA6, 12, PA6, 14, PA6, 18, PA8,8, PA8, 10, PA8, 12, PA10, 10, PA10, 12, PA10, 14, PA10, 18, PA12, 10, PA12, 12, PA12, 14, PA12, 18, PA13, 13, PA14, 10, PA14, 12, PA14, 14, PA14, 18 and PA6,36, more preferably is PA4, 10, PA5, 10, PA6, 10, PA6, 12, PA6, 18, PA10, 10, PA10, 12, PA12, 10, PA12, 12, PA11 and/or PA12.

Additionally, the polyamide in the first aspect of the present invention can include blends of at least one polyamide as described above and/or polyamide copolymerized co-polyamide. The polyamide copolymerized co-polyamide in the first aspect of the present invention is the polyamide copolymer comprising at least one repeating unit (repeating unit A) of any of Formula (I) or Formula (II), and at least one repeating unit (repeating unit B) of any of Formula (I) other than repeating unit A, Formula (II) other than repeating unit A, Formula (III) and/or Formula (IV). The Formula (III) or Formula (IV) has the following structure:

[symbol]

NH—R⁴—CO [symbol] Formula (III);

[symbol]

NH—R⁵—NH—CO—R⁶—CO [symbol] Formula (IV);
R⁴ equals to or differs from each other, is a divalent hydrocarbon group having from 2 to 7 carbon atoms, preferably from 3 to 5 carbon atoms;
R⁵ equals to or differs from each other, is a divalent hydrocarbon group having from 2 to 8 carbon atoms, preferably from 2 to 6 carbon atoms;
R⁶ equals to or differs from each other, is a divalent hydrocarbon group having from 1 to 6 carbon atoms.

The divalent hydrocarbon group of R⁴, R⁵ or R⁶ is preferably alkylene group and/or cycloalkylene group, respectively, more preferably is alkylene group.

The polyamide comprising a repeating unit of Formula (III) can be typically derived from at least one aliphatic monomer which is selected from the group consisting of (e) lactam having from 3 to 8 carbon atoms, (f) amino acid having from 3 to 8 carbon atoms.

The lactam having from 3 to 8 carbon atoms preferably has from 3 to 6 carbon atoms, preferably could be any of β-Lactam, caprolactam, heptanelactam, capryllactam, and mixtures thereof.

The amino acid having from 3 to 8 carbon atoms preferably has from 4 to 6 carbon atoms, preferably could be 5-amino-pentanoic acid.

The polyamide comprising a repeating unit of Formula (IV) can be typically derived from at least one aliphatic monomer which is selected from the group consisting of (g) aliphatic dicarboxylic acid having from 3 to 8 carbon atoms and aliphatic diamine having from 2 to 8 carbon atoms; (h) aliphatic dicarboxylic acid chloride having from 3 to 8 carbon atoms and aliphatic diamine having from 2 to 8 carbon atoms.

The aliphatic dicarboxylic acid having from 3 to 8 carbon atoms could be any of malonic acid, succinic acid, glutaric acid, adipic acid, pimelic acid, suberic acid, and mixtures thereof.

The aliphatic diamine having from 2 to 8 carbon atoms could be any of 1,2-diaminoethane, 1,2-diaminopropane, propylene-1,3,-diamine, 1,3-diaminobutane, 1,4-diaminobutane, 1,5-diaminopentane, 1,4-diamino-1,1,-dimentylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diaminohexane, 1,7-diamnoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, and mixtures thereof.

The aliphatic dicarboxylic acid chloride having from 3 to 8 carbon atoms could be any of malonamide, succinimide, glutaryl chloride, adipoyl chloride, pimeloyl chloride, suberoyl chloride, and mixtures thereof.

The examples of repeating unit B could be PA6, PA4,6, PA6,6. Examples of co-polyamide could be PA6/PA6, 36, PA6,6/PA4, 10, PA6,6/PA6, 10, PA6/PA6, 10, PA6,6/PA6, 12, PA6/PA6, 12.

There is no limitation of the type of the copolymer, which could be block copolymer, random copolymer, graft copolymer or alternating copolymer.

The polyamide according to the first aspect of the present invention could have the conventional molecule weight in the polyamide composition, the relative viscosity of the polyamide is preferable 1.8-4.0 measured in sulfuric acid solution of 96 wt % at 25° C. according to ISO 1628.

The polyamide composition according to the first aspect of the present invention is preferably in the amount of 55-85 wt %, more preferably is of 60-80 wt %, most preferably is of 70-75 wt % based on the total weight of the polyamide composition.

The below description to the polyamide is related to the second aspect of the present invention.

According to the second aspect of the present invention, a polyamide composition, comprising at least two polyamides, hollow glass bubbles, and impact modifier is provided, wherein one of at least two polyamides has a repeating unit of Formula (V), the other one of the at least two polyamides has a repeating unit of Formula (VI) or Formula (VII); Formula (V) and Formula (VI) has following structures:

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ equals to or differs from each other, is a divalent hydrocarbon group having from 4 to 6 carbon atoms, preferably from 5 or 6 carbon atoms;
R⁸ equals to or differs from each other, is a divalent hydrocarbon group, having from 7 to 10 carbon atoms, preferably from 8 to 10 carbon atoms;
R⁹ equals to or differs from each other, is a divalent hydrocarbon group having from 10 to 39 carbon atoms, preferably from 10 to 24 carbon atoms, more preferably from 10 to 18, most preferably having 10, 11, 12, 13 and/or 14 carbon atoms;
R¹⁰ equals to or differs from each other, is a divalent hydrocarbon group having from 6 to 40 carbon atoms, preferably from 6 to 24 carbon atoms, more preferably from 6 to 18, most preferably having 6, 9, 10, 11, 12, 13 and/or 14 carbon atoms;
R¹¹ equals to or differs from each other, is a divalent hydrocarbon group having from 8 to 38 carbon atoms, preferably from 8 to 20 and 34 carbon atoms, more preferably having 8, 9, 10, 11, 12, 13, 14, 15, 16, 17, 18 and/or 34 carbon atoms; the total number of carbon atom in Formula (VII) is more than 18.

The divalent hydrocarbon group of R⁷, R⁸, R⁹, R¹⁰, or R¹¹ is preferably alkylene group and/or cycloalkylene group, respectively, more preferably is alkylene group.

The polyamide comprising a repeating unit of Formula (V) can be typically derived from at least one aliphatic monomer which is selected from the group consisting of (i) aliphatic dicarboxylic acid having from 9 to 12 carbon atoms and aliphatic diamine having from 4 to 6 carbon atoms; (j) aliphatic dicarboxylic acid chloride having from 9 to 12 carbon atoms and aliphatic diamine having from 4 to 6 carbon atoms.

The aliphatic dicarboxylic acid having from 9 to 12 carbon atoms could be any of azelaic acid, sebacic acid, dodecandioic acid and mixtures thereof.

The aliphatic dicarboxylic acid chloride having from 9 to 12 carbon atoms could be any of azelaoyl chloride, sebacoyl chloride, and mixtures thereof.

The aliphatic diamine having from 4 to 6 carbon atoms could be any of 1,3-diaminobutane, 1,4-diaminobutane, 1,5-diaminopentane, 1,4-diamino-1,1,-dimentylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diaminohexane.

Examples of the polyamide comprising a repeating unit of Formula (V) could be PA4, 10, PA5, 10, PA6, 10, PA6,9, PA6, 12 and mixture thereof, preferably is PA5, 10, PA6, 10, PA6, 12, and mixtures thereof.

The polyamide comprising a repeating unit of Formula (VI) can be typically derived from at least one aliphatic monomer which is selected from the group consisting of (k) lactam having from 11 to 40 carbon atoms, (I) amino acid having from 11 to 40 carbon atoms.

The lactam having from 11 to 40 carbon atoms preferably has from 11 to 20 carbon atoms, preferably could be any of undecanolactam, laurolactam, and mixtures thereof.

The amino acid having from 11 to 40 carbon atoms preferably has from 11 to 20 carbon atoms, preferably could be 11-aminoundecanoic acid, 12-aminododecanoic acid, and mixtures thereof.

The polyamide comprising a repeating unit of Formula (VII) can be typically derived from at least one aliphatic monomer which is selected from the group consisting of (m) aliphatic dicarboxylic acid having from 10 to 40 carbon atoms and aliphatic diamine having from 6 to 40 carbon atoms; (n) aliphatic dicarboxylic acid chloride having from 10 to 40 carbon atoms and aliphatic diamine having from 6 to 40 carbon atoms.

The aliphatic dicarboxylic acid having from 10 to 40 carbon atoms preferably has from 10 to 22 and 36 carbon atoms, more preferably has 10, 11, 12, 13, 14, 15, 16, 17, 18 and/or 36 carbon atoms. The aliphatic dicarboxylic acid having from 10 to 40 carbon atoms could be any of sebacic acid, undecanedioic acid, dodecandioic acid, tridecanedioic acid, tetradecandioic acid, pentadecanoic acid, hexadecanedioic acid, octadecandioic acid, dimer acid having 36 carbon atoms, and mixtures thereof.

The aliphatic diamine having from 6 to 40 carbon atoms preferably has from 6 to 24 carbon atoms, more preferably has from 6 to 18 carbon atoms, most preferably has 6, 9, 10, 11, 12, 13 and 14 carbon atoms. The aliphatic diamine having from 6 to 40 carbon atoms could be linear aliphatic diamine or branched aliphatic diamine, preferably is any of 1,6-diaminohexane, 1,9-diaminononane, 1,10-diaminodecane, 1,11-diaminoundecane, 1,12-diaminododecane, 1,13-tridecanediamine, 1,14-tetradecanediamine, 1,16-hexadecanediamine, 1,18-octadecanediamine, 1,20-eicosanediamine, 1,22-docosanediamine, 2,2,4-trimethylhexane-1,6-diamine, 2,4,4-trimethylhexane-1,6-diamine, 2-methyl-1,8-octanediamine, 1,3-dimethyloctane-1,8-diamine, 1,4-dimethyloctane-1,8-diamine, 2,4-dimethyloctane-1,8-diamine, 3,4-dimethyloctane-1,8-diamine, 4,5-dimethyloctane-1,8-diamine, 2,2-dimethyloctane-1,8-diamine, 3,3-dimethyloctane-1,8-diamine, 4,4-dimethyloctane-1,8-diamine, 2,4-diethylhexane-1,6-diamine, 5-methylnonane-1,9-diamine, and mixtures thereof.

The aliphatic dicarboxylic acid chloride having from 10 to 40 carbon atoms preferably has from 10 to 20 carbon atoms, more preferably has 10, 11, 12, 13, 14, 15, 16, 17, 18 carbon atoms. The dicarboxylic acid chloride having from 10 to 40 carbon atoms could be any of sebacoyl chloride, undecanedioyl dichloride, and mixtures thereof.

Examples of the polyamide having a repeating unit of Formula (VI) or Formula (VII) could be PA11, PA12, PA13, PA10,10, PA10,12, PA12,12, PA6,36 and mixture thereof, preferably is PA10, 12, PA10, 10, and PA12, 12, and mixture thereof.

Additionally, the polyamide according to the second aspect of the present invention can include polyamide copolymerized co-polyamide. There is no limitation of the type of the copolymer, for example block copolymer, random copolymer, graft copolymer or alternating copolymer.

Examples of copolymers of the polyamides having Formula (V) are PA6,6/PA4, 10, PA6,6/PA6, 10, PA6/PA6, 10, PA6,6/PA6, 12, PA6/PA6, 12. Examples of copolymers of the polyamides having Formula (VII) are PA6,6/PA6,36.

The at least two polyamides according to the second aspect of the present invention could independently have the conventional molecule weight in polyamide composition, the relative viscosity of the polyamide is preferable 1.8-4.0 measured in sulfuric acid solution of 96 wt % at 25° C. according to ISO1628.

The polyamide having a repeating unit of Formula (V) and the polyamide having a repeating unit of Formula (VI) or Formula (VII) is preferably in a weight ratio of from 1.5:1 to 4.5:1, more preferably in a weight ratio of from 2:1 to 4:1.

The combination of the at least two polyamides according to the second aspect of the present invention is preferably in the amount of 55-85 wt %, more preferably is of 60-80 wt %, most preferably is of 70-75 wt % based on the total weight of the polyamide composition.

The hollow glass bubbles in the invention have the same meaning with “hollow glass microspheres”, “hollow glass beads”, “glass microbubbles” or “glass balloons”. According to the present invention, the hollow glass bubbles have a core and shell construction, where the core is hollow, and is filled with a gas either at atmospheric pressure or at reduced pressure. The shell is primarily made of glass containing silicon dioxide (SiO₂) as a main component, with sodium oxide (Na₂O), magnesium oxide (MgO), calcium oxide (CaO), boron oxide (B₂O₅), phosphorus oxide (P₂O₅), and the like as accessory components.

According to the invention, the hollow glass bubbles preferably have a 10 volume % isostatic collapse strength of 8000 PSI (55 MPa) or higher, more preferably 10,000 PSI (69 MPa) or higher, and most preferably 16,000 PSI (110 MPa) or higher. Herein, the 10 volume % isostatic collapse strength of the hollow glass microspheres is defined by ASTM D-3102-78, where an appropriate quantity of glass bubbles are placed in glycerin and pressurized, and the pressure where 10 volume % are crushed is used as an indicator.

Furthermore, with regards to a size of the hollow glass bubbles, a median diameter (volumetric % diameter) is preferably from 10 μm to 70 μm, more preferably from 10 μm to 35 μm. Furthermore, a 90 volume % diameter is preferably controlled within a range of 30 μm to 200 μm, more preferably 30 μm to 70 μm. The size of the hollow glass bubble can be measured using a commercial laser diffraction particle size analyzer (wet type, recirculating).

Furthermore, the true density of the hollow glass bubbles is the quotient obtained by dividing the mass of a sample of hollow glass bubbles by the true volume of that mass of hollow glass bubbles as measured by a gas pycnometer. The true density of the hollow glass bubbles in the present invention is preferably 0.9 g/cm³ or less, more preferably 0.3 to 0.7 g/cm³, even more preferably 0.4 to 0.6 g/cm³. The true density of the hollow glass bubbles is typically measured using ASTM D2840-69, “Average True Particle Density of Hollow Microspheres”.

According to the invention, the hollow glass bubbles can be surface treated with a coupling agent such as a zirconate, silane, or titanate, urethane, and/or epoxide. Typical titanate and zirconate coupling agent are known to one skilled in the art and a detailed overview of the uses and selection criteria for these materials can be found in Monte, S. J., Kenrich Petrochemicals, Inc., “Ken-React® Reference Manual-Titanate, Zirconate and Aluminate Coupling agent”, Third Revised Edition, March 1995. Suitable silanes are coupled to glass surfaces through condensation reactions to form siloxane linkages with the siliceous glass. The treatment renders the microspheres more wet-able or promotes the adhesion of materials to the glass bubble surface. This provides a mechanism to bring about covalent, ionic or dipole bonding between hollow glass bubbles and organic matrices.

The silane coupling agent in the invention could be the silane coupling agent commonly used for polyamide resin, preferable is at least one selected from the group consisting of epoxy functional silane, urethane functional silane and amino ureide functional silane, more preferable is at least one selected from the group consisting of epoxycyclohexyl functional silane, glycidoxy functional silane, isocyanate functional silane and amino ureide functional silane, most preferably is at least one selected from 2-(3,4-epoxycyclohexyl) ethyltrimethoxysilane, 3-glycidoxypropyl methyldimethoxysilane, 3-glycidoxypropyl trimethoxysilane, 3-glycidoxypropyl methyldiethoxysilane, 3-glycidoxypropyl triethoxysilane, N-2-(aminoethyl)-3-aminopropylmethyldimethoxysilane, N-2-(aminoethyl)-3-aminopropyltrimethoxysilane, N-2-(aminoethyl)-3-aminopropylmethyldimethoxysilane, N-2-(aminoethyl)-3-aminopropyltributoxysilane, N-2-(aminoethyl)-3-aminopropylmethyldiethoxysilane, N-2-(aminoethyl)-3-aminopropyltriethoxysilane, 3-aminopropyltrimethoxysilane, 3-aminopropylmethyldiethoxysilane, 3-aminopropylmethyldimethoxysilane, 3-aminopropyldimethylmethoxysilane, 3-aminopropyldimethylethoxysilane, 3-aminopropyltriethoxysilane, 3-triethoxyysily-N-(1,3-dimethyl-butylidene)propylamine, N-phenyl-3-aminopropyltrimethoxysilane, N-(vinylbenzyl)-2-aminoethyl-3-aminopropyltrimethoxysilane hydrochloride, 3-ureidopropyltrialkoxysilane and 3-isocyanatepropyltriethoxysilane.

The hollow glass bubbles are preferably surfaced treated with from 0.5 to 3 wt % of coupling agent, based on the weight of hollow glass bubbles.

The hollow glass bubbles treated with coupling agent could use conventional method to apply the coupling agent to the surfaces of hollow glass bubbles so long as the coupling agent could be on the surface of pure hollow glass bubbles, such as spraying, dipping, or mixing, preferable is spraying.

An example of commercial hollow glass bubbles that can be used is 3M (trademark) Glass Bubbles. Grades of product that can be used include S60HS (true density 0.6 g/cm³, 10 volume % isostatic collapse strength 18,000 PSI or higher (124 MPa or higher), iM30K (true density 0.6 g/cm³, 10 volume % isostatic collapse strength 27,000 PSI or higher (186 MPa or higher), S60 (true density 0.6 g/cm³, 10 volume % isostatic collapse strength 10,000 PSI or higher (69 MPa), K42HS (true density 0.42 g/cm³, 10 volume % isostatic collapse strength 8000 PSI or higher (55 MPa or higher), or the like.

The hollow glass bubbles in the polyamide composition is preferably in the amount of 5-30 wt %, more preferably is of 10-25 wt %, most preferably is of 15-20 wt % based on the total weight of the polyamide composition.

In general, all kinds of impact modifier could be used in the polyamide composition in the present invention, as long as no converse effect occurs.

In one preferred embodiment, ethylene-based and styrene-based elastomers can be used as impact modifiers. The ethylene-based elastomers include but are not limited to an elastomer derived from ethylene-α-olefin, an elastomer consisting of ethylene-α-olefin-diene, an elastomer consisting of ethylene-unsaturated carboxylic acid, an elastomer consisting of ethylene-unsaturated carboxylic acid ester, an elastomer consisting of ethylene-unsaturated carboxylic acid-unsaturated carboxylic acid ester, an elastomer consisting of ethylene-α-olefin-unsaturated carboxylic acid-unsaturated carboxylic acid ester. The styrene-based elastomers include but are not limited to styrene-isobutylene/styrene-hydrogenated polyolefin, styrene-ethylene-butadiene-styrene copolymer (briefed as SEBS), styrene-butadiene-styrene copolymer. Graft modified materials of the above-mentioned elastomers can be used.

Examples of the alpha-olefin are propylene, 1-butylene, isobutene, 1-pentene, 1-hexene, 1-octene, 4-methyl-1-pentene, 3-methyl-1-pentene, 3,5,5-trimethyl-1-hexene, 1-decene and mixture thereof, more preferably is propylene, 1-butene, 1-hexene, isobutene, 1-octene, mixture of propylene and 1-butene, and mixture of 1-decene and 1-methyl-1-pentene, most preferably is 1-butene, isobutene, 1-propylene, 1-pentene, 1-octene.

The ethylene-α-olefin elastomer is preferably ethylene-butene copolymer, ethylene-propylene copolymer, ethylene-pentene copolymer, ethylene-isobutene copolymer, and/or ethylene-octene copolymer.

The diene is preferably conjugated diene, more preferably is 1,3-butadiene, 1,3-pentadiene, isoprene, 1,3-hexadiene and mixtures thereof, more preferably is 1,3-butadiene, 1,3-pentadiene and/or isoprene, most preferably is 1,3-butadiene.

The unsaturated carboxylic acid has at least one carbon-carbon double bond and at least one carboxyl group. Examples of the ethylenically unsaturated carboxylic acid is mono-olefinic acid and polyolefinic unsaturated mono-, and poly-carboxylic acid(di-, tri-carboxylic acid), preferably is acrylic acid, methacrylic acid, maleic acid, fumaric acid, glutaconic acid, itaconic acid, citraconic acid, 2-ethylacrylic acid, 2-chloroacrylic acid, crotonic acid, isocrotonic acid, angelic acid, sorbic acid, mesaconic acid, cinnamic acid, p-chloro cinnamic acid, 3,4,5,6-tetrahydrophthalic acid, 1,2,3,6-tetrahydrophthalic acid, bicyclo (2.2.2)-octa-5-ene-2,3-dicarboxylic acid, 4-methylcyclohexa-4-ene-1,2-dicarboxylic acid, 1,2,3,4,5,8,9,10-octahydronaphthalene-2,3-dicarboxylic acid, bicyclo (2.2.1) octa-7-ene-2,3,5,6-tetracarboxylic acid, maleopimaric acid and 7-oxabicyclo (2.2.1) hepta-5-ene-2,3-dicarboxylic acid, more preferably is acrylic acid, methacrylic acid, maleic acid, fumaric and/or citraconic acid.

The ester of the ethylenically unsaturated carboxylic acid is preferably the ester of acrylic acid and/or acetic acid, more preferably is an alkyl ester and/or a hydroxy alkyl ester of acrylic acid and/or acetic acid, such as C1-C18, more preferably C1-C12, most preferably C1-C4 alkyl ester and/or C1-C18, more preferably C1-C12, most preferably C1-C4 hydroxy alkyl ester of acrylic acid and/or acetic acid. Examples of the ester of the ethylenically unsaturated carboxylic acid are methyl methacrylate, methyl acrylate, ethyl methacrylate, ethyl acrylate, propyl acrylate, propyl methacrylate, butyl acrylate, butyl methacrylate, isobutyl acrylate, isobutyl methacrylate, 2-ethylhexyl acrylate, octyl acrylate, otctyl methacrylate, decyl acrylate, decyl methacrylate, isodecyl acrylate, isodecyl methacrylate, lauryl acrylate, lauryl methacrylate, dimethyl maleate, monomethyl maleate, hydroxyethyl methacrylate (HEMA), stearyl methacrylate, stearyl acrylate, isobornyl acrylate, isobornyl methacrylate, hydroxypropyl methacrylate and vinyl acetate; more preferably is methyl methacrylate, methyl acrylate, ethyl methacrylate, ethyl acrylate, propyl acrylate, propyl methacrylate, butyl acrylate, butyl methacrylate, isobutyl acrylate, and/or isobutyl methacrylate, most preferably is methyl methacrylate, methyl acrylate, butyl acrylate and/or butyl methacrylate.

According to the first aspect of the present invention, the combination of grafted impact modifier and non-grafted impact modifier both selected from ethylene-based and styrene-based elastomers, when used together with the polyamide and hollow glass bubbles, can significantly improve the impact resistance including elongation, achieve an excellent balance in stiffness and toughness while the density kept decreased.

According to the first aspect of the present invention, the impact modifier at least includes non-grafted impact modifier and grafted impact modifier both selected from ethylene-based and styrene-based elastomers. The grafted impact modifier refers to the above-mentioned impact modifier grafted with reactive groups. The reactive groups include but are not limited to the carboxyl, acid anhydride, epoxy, sulphonic acid or acid chloride groups. Preferably, the reactive groups are carboxyl, acid anhydride and epoxy, more preferably, the reactive groups are epoxy groups and anhydrides of maleic acid, itaconic acid, and citraconic acid and most preferably, the reactive groups are anhydrides of maleic acid.

The graft ratio of the grafted impact modifier is about 0.2 to 3 wt %, preferably is about 0.5 to 2 wt %, based on the total weight of the grafted impact modifier.

The acid anhydride is preferably selected from the group consisting of maleic anhydride (MAH), acrylic anhydride, methacrylic anhydride, 4-methyl cyclohex-4-ene-1,2-dicarboxylic acid anhydride, itaconic anhydride, citraconic anhydride, fumaric anhydride, 3,4,5,6-tetrahydrophthalic anhydride, 1,2,3,6-tetrahydrophthalic anhydride, bicyclo(2.2.2)oct-5-ene-2,3-dicarboxylic acid anhydride, 1,2,3,4,5,8,9,10-octahydronaphthalene-2,3-dicarboxylic acid anhydride, bicyclo(2.2.1)hept-5-ene-2,3-dicarboxylic acid anhydride, tnorborn-5-ene-2,3-dicarboxylic acid anhydride, nadic anhydride, methyl nadic anhydride, himic anhydride, methyl himic anhydride and x-methylbicyclo(2.2.1)hept-5-ene-2,3-dicarboxylic acid anhydride (XMNA), more preferably is maleic anhydride, (meth)acrylic anhydride, fumaric anhydride, itaconic anhydride, and/or citraconic anhydride.

The epoxy group could be carboxylic acid glycidyl ester, glycidyl ether, and/or the like. Examples of the epoxy group are glycidyl acrylate, glycidyl methacrylate, maleic acid 1-glycidyl ester, diglycidyl ester of maleic acid, monoglycidyl ester of itaconic acid, diglycidyl ester of itaconic acid, mono glycidyl ester of citraconic acid, diglycidyl ester of citraconic acid, monoglycidyl ester of butenetricarboxylic acid, diglycidyl ester of butenetricarboxylic acid, triglycidyl ester of butenetricarboxylic acid, vinyl glycidyl ether, allyl glycidyl ether, 2-methylallyl glycidyl ether, phenyl glycidyl ether, and 4-vinylbenzyl glycidyl ether, preferably is glycidyl acrylate and/or glycidyl methacrylate.

According to the first aspect of the present invention, the total amount of the non-grafted impact modifier and grafted impact modifier in the polyamide composition is preferably in the amount of 3-20 wt %, more preferably is of 5-15 wt % based on the total weight of the polyamide composition. The weight ratio of the non-grafted impact modifier to the grafted impact modifier is preferably in the range from 1:3 to 3:1, more preferably 1:2 to 2:1, most preferably 1.5:1:1:1.5, for example 0.9:1, 1:1, 1:0.9

In a preferred embodiment of the first aspect of the present invention, the impact modifier includes non-grafted styrene-based elastomers and grafted styrene-based elastomers. The grafted reactive group of the grafted styrene-based elastomers is preferably acid anhydride and/or epoxy.

In a preferred embodiment of the first aspect of the present invention, the impact modifier includes non-grafted ethylene-based elastomers and grafted ethylene-based elastomers. The grafted reactive group of the grafted ethylene-based elastomers is preferably acid anhydride and/or epoxy.

In a specific embodiment of the first aspect of the present invention, the impact modifier includes a combination of SEBS and maleic anhydride grafted SEBS (briefed as SEBS-g-MAH). The weight ratio between SEBS and maleic anhydride grafted SEBS is preferably at 1:2 to 2:1, more preferably at 1.5:1 to 1:1.5.

According to the second aspect of the present invention, it has been surprisingly found that a combination of at least two polyamides having a repeating unit of Formula (V) and Formula (VI)/(VII), when used together with hollow glass bubbles and impact modifier selected from ethylene-based and styrene-based elastomers, can significantly improve the impact resistance including elongation, achieve an excellent balance in stiffness and toughness while the density kept decreased. There is no specific limit to the impact modifier, which can be either grafted impact modifier, non-grafted impact modifier or both. A combination of grafted impact modifier and non-grafted impact modifier as described above can also be applied in this embodiment.

According to the second aspect of the present invention, all kinds of impact modifier could be used in the polyamide composition in the present invention. The impact modifier could be selected from the group consisting of ethylene-based elastomers, grafted ethylene-based elastomers, styrene-based elastomers, grafted ethylene-based elastomers, and mixture thereof.

In one preferred embodiment of the second aspect of the present invention, the impact modifier could be grafted ethylene-based elastomers and/or grafted styrene-based elastomers, the grafted reactive group of the grafted ethylene-based or styrene-based elastomers is preferably acid anhydride and/or epoxy. The acid anhydride is maleic anhydride and/or (meth)acrylic anhydride, the epoxy is preferably glycidyl acrylate and/or glycidyl methacrylate.

The ethylene-based elastomer could be selected from the group consisting of ethylene-α-olefin, an elastomer consisting of ethylene-α-olefin-diene, an elastomer consisting of ethylene-unsaturated carboxylic acid, an elastomer consisting of ethylene-unsaturated carboxylic acid ester, an elastomer consisting of ethylene-unsaturated carboxylic acid-unsaturated carboxylic acid ester, an elastomer consisting of ethylene-α-olefin-unsaturated carboxylic acid-unsaturated carboxylic acid ester. The styrene-based elastomers include but are not limited to styrene-isobutylene/styrene-hydrogenated polyolefin, styrene-ethylene-butadiene-styrene copolymer, styrene-butadiene-styrene copolymer.

In a specific embodiment of the second aspect of the present invention, the impact modifier is acid anhydride grafted ethylene-based elastomers. The acid anhydride is preferably maleic anhydride and/or (meth)acrylic anhydride.

In a specific embodiment of the second aspect of the present invention, the impact modifier is glycidyl methacrylate grafted ethylene-based elastomers.

In a specific embodiment of the second aspect of the present invention, the impact modifier is maleic anhydride or glycidyl methacrylate grafted ethylene-octene copolymer.

In a specific embodiment of the second aspect of the present invention, the impact modifier is acid anhydride grafted styrene-based elastomer. The acid anhydride is preferably maleic anhydride and/or glycidyl methacrylate.

In a specific embodiment of the second aspect of the present invention, the impact modifier is maleic anhydride grafted styrene-ethylene-butadiene-styrene copolymer.

In a specific embodiment of the second aspect of the present invention, the impact modifier is the combination of grafted impact modifier and non-grafted impact modifier. The weight of grafted impact modifier to the non-grafted impact modifier could be from 3:1 to 1:3, preferably is from 2:1 to 1:2, more preferably is from 1.5:1 to 1:1.5.

In a specific embodiment of the second aspect of the present invention, the impact modifier is the combination of grafted impact modifier and non-grafted impact modifier, the non-grafted impact modifier is ethylene-based and/or styrene-based elastomers, the grafted impact modifier is acid anhydride or epoxy grafted ethylene-based and/or styrene-based elastomers, preferably is the combination of acid anhydride grafted ethylene-α-olefin copolymer and ethylene-α-olefin copolymer, the combination of acid anhydride grafted styrene-based elastomer and styrene-based elastomer. The weight of grafted impact modifier to the non-grafted impact modifier could be from 3:1 to 1:3, preferably is from 2:1 to 1:2, more preferably is from 1.5:1 to 1:1.5.

In a specific embodiment of the second aspect of the present invention, the impact modifier is the combination of acid anhydride grafted ethylene-octene copolymer and ethylene-octene copolymer, acid anhydride grafted SEBS and SEBS. The acid anhydride is preferably maleic anhydride. The weight of grafted impact modifier to the non-grafted impact modifier could be from 3:1 to 1:3, preferably is from 2:1 to 1:2, more preferably is from 1.5:1 to 1:1.5.

According to the second aspect of the present invention, the total amount of the impact modifier is preferably in the amount of 3-20 wt %, more preferably is of 5-15 wt %, most preferably is of 5-10 wt %, based on the total weight of the polyamide composition.

The polyamide composition of the present invention could also comprise various additives so long as the additives do not adversely affect the desired properties of the polyamide composition in the invention. Preferably, the polyamide composition of the present invention does not comprise any glass fiber.

The additives could include surface effect additive, antioxidant, colorant, heat stabilizer, light stabilizer, flow modifier, plasticizer, demolding agent, flame retardant, anti-drip agent, radiation stabilizer, ultraviolet absorbing, ultraviolet light stabilizer, release agent, and/or antimicrobial agent.

The heat stabilizer could be the conventional heat stabilizer, such as copper heat stabilizer and/or organic amine heat stabilizer, for example Irganox 1098.

The light stabilizer could be the conventional light stabilizer, such as hindered amine compounds, benzophenone, benzotriazole and/or salicylates light stabilizer. The preferred light stabilizer could be 2-hydroxy-4-n-octoxy benzophenone, 2-(2-hydroxy-5-methylphenyl) benzotriazole, aryl salicylates, and/or 2-(2-hydroxy-5-tert-octylphenyl) benzotriazole, etc.

The lubricant could be the conventional lubricant for polyamide composition, such as stearate, polyethylene wax, ethylene bisstearamide (EBS), fatty acid ester, wax, phthalic acid ester and/or silicones, etc.

The flame retardant could be the conventional flame retardant, for example the inorganic flame retardant and/or organic flame retardant. The organic flame retardant could include phosphorus, brominated, chlorinated and/or nitrogen flame retardant. Examples of nitrogen flame retardant are selected from the group consisting of benzoguanamine, tris(hydroxyethyl)isocyanurate, isocyanurate, melamine, melamine cyanurate.

Examples of phosphorus flame retardant are selected from the group consisting of ethylenediamine phosphate, piperazine phosphate, piperazine pyrophosphate, dialkylphosphate.

The total content of the additives in the polyamide composition is preferably 0-10 wt %, more preferably is 0.5-5 wt %, most preferably 0.5-2 wt % based on the total weight of the polyamide composition.

The present invention also discloses a manufacturing method of the polyamide composition, comprising combining all components of the polyamide composition.

In a preferred embodiment, the combining could be extruding or melt kneading. Preferred process of extruding is: all the components of the polyamide composition except for hollow glass bubbles being fed into the main throat of a screw extruder, the hollow glass bubbles being fed at a down-stream mineral throat into the screw extruder, and extruding.

The present invention also discloses an application of the polyamide composition in the light-weight parts, especially in the light-weight parts for vehicles.

The present invention also discloses an article prepared from or preparable from the polyamide composition in the invention.

The polyamide composition described is incorporated into the article as part of mobile electronic devices or automobile components. The part could be a light-weight one.

As used herein, a mobile electronic device refers to an electronic device that its user can easily carry and used in various locations. A mobile electronic device can include, but not limited to mobile computers such as a tablet computer, a laptop computer, a pocket calculator, portable media player, mobile internet device (MID), handheld PC, handheld game console, digital media player, mobile phones such as a smart phone, a phablet, wearable computers such as a smart watch, a head-mounted display, a virtual reality headsets, a digital camera, a global positioning system receiver, a portable power source, a portable Wi-Fi, a portable media player, a pocket calculator, and a e-book reader. The part herein is the one that at least partially comprises the polyamide composition.

In some embodiments, the part could be a frame, housing, connector, cover, circuit board of the mobile electronic device.

As used herein, the automobile component includes but not limited to interior and exterior automobile components, for example hoods, trunks, bumpers, grilles, side claddings, rocker panels, fenders, tail-gates, in wire and cable applications, instrument panels, consoles, interior trim, exterior trim, door panels, heater housings, battery supports, headlight housings, front ends, ventilator wheels, reservoirs, and soft pads.

In some embodiments, the automobile component could be interior trim, console, and exterior trim.

The present invention has the following benefits: the polyamide composition has low density which fulfills the requirement of light weight plastic parts for automobile fields and mobile electronic device. Meanwhile, the polyamide composition could balance the low density and the good mechanical properties.

In the present invention, all the technical features mentioned above could be freely combined to form the preferred embodiments.

The specific embodiments of the invention are as follows:

Specific embodiment 1 is a polyamide composition comprising:
a) 55-85 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
b) 5-30 wt % of hollow glass bubbles;
c) 3-20 wt % of a combination of grafted impact modifier and non-grafted impact modifier; and
d) 0-10 wt % of additives; based on the total weight of the polyamide composition.

Specific embodiment 2 is a polyamide composition comprising:
a) 55-85 wt % of at least one polyamide selected from a polyamide having a repeating unit of Formula (I), and a polyamide having a repeating unit of Formula (II),

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 19 carbon atoms;
R² independently equals to or differs from each other, is an alkylene group having from 4 to 24 carbon atoms;
R³ independently equals to or differs from each other, is an alkylene group having from 8 to 36 carbon atoms;
b) 5-30 wt % of hollow glass bubbles;
c) 3-20 wt % of a combination of grafted impact modifier and non-grafted impact modifier; and
d) 0-10 wt % of additives; based on the total weight of the polyamide composition.

Specific embodiment 3 is a polyamide composition comprising:
a) 55-85 wt % of at least one polyamide selected from a polyamide having a repeating unit of Formula (I), and a polyamide having a repeating unit of Formula (II),

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 12 carbon atoms;
R² independently equals to or differs from each other, is an alkylene group having from 4 to 18 carbon atoms;
R³ independently equals to or differs from each other, is an alkylene group having from 8 to 20 and 34 carbon atoms;
b) 5-30 wt % of hollow glass bubbles;
c) 3-20 wt % of a combination of grafted impact modifier and non-grafted impact modifier; and
d) 0-10 wt % of additives; based on the total weight of the polyamide composition.

Specific embodiment 4 is a polyamide composition comprising:
a) 60-80 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
b) 10-25 wt % of hollow glass bubbles;
c) 3-20 wt % of a combination of grafted impact modifier and non-grafted impact modifier; and
d) 0-10 wt % of additives; based on the total weight of the polyamide composition.

Specific embodiment 5 is a polyamide composition comprising:
a) 60-80 wt % of at least one polyamide selected from a polyamide having a repeating unit of Formula (I), and a polyamide having a repeating unit of Formula (II),

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 19 carbon atoms;
R² independently equals to or differs from each other, is an alkylene group having from 4 to 24 carbon atoms;
R³ independently equals to or differs from each other, is an alkylene group having from 8 to 36 carbon atoms;
b) 10-25 wt % of hollow glass bubbles;
c) 3-20 wt % of a combination of grafted impact modifier and non-grafted impact modifier; and
d) 0-10 wt % of additives; based on the total weight of the polyamide composition.

Specific embodiment 6 is a polyamide composition comprising:
a) 60-80 wt % of at least one polyamide selected from a polyamide having a repeating unit of Formula (I), and a polyamide having a repeating unit of Formula (II),

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 12 carbon atoms;
R² independently equals to or differs from each other, is an alkylene group having from 4 to 18 carbon atoms;
R³ independently equals to or differs from each other, is an alkylene group having from 8 to 20 and 34 carbon atoms;
b) 10-25 wt % of hollow glass bubbles;
c) 3-20 wt % of a combination of grafted impact modifier and non-grafted impact modifier; and
d) 0-10 wt % of additives; based on the total weight of the polyamide composition.

Specific embodiment 7 is a polyamide composition comprising:
a) 55-85 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
b) 5-30 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer;
d) 0-10 wt % of additives; based on the total weight of the polyamide composition.

Specific embodiment 8 is a polyamide composition comprising:
a) 55-85 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
b) 5-30 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer; the grafted reactive group of the grafted impact modifier is carboxyl, acid anhydride, epoxy, sulphonic acid or acid chloride groups; and
d) 0-10 wt % of additives; based on the total weight of the polyamide composition.

Specific embodiment 9 is a polyamide composition comprising:
a) 55-85 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
b) 5-30 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer; the grafted reactive group of the grafted impact modifier is carboxyl, acid anhydride, epoxy, sulphonic acid or acid chloride groups; the weight ratio of the non-grafted impact modifier to the grafted impact modifier is from 1:3 to 3:1, preferably from 2:1 to 1:2, more preferably from 1.5:1 to 1:1.5; and
d) 0-10 wt % of additives; based on the total weight of the polyamide composition.

Specific embodiment 10 is a polyamide composition comprising:
a) 55-85 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 19 carbon atoms;
R² independently equals to or differs from each other, is an alkylene group having from 4 to 24 carbon atoms;
R³ independently equals to or differs from each other, is an alkylene group having from 8 to 36 carbon atoms;
b) 5-30 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer; the grafted reactive group of the grafted impact modifier is carboxyl, acid anhydride, epoxy, sulphonic acid or acid chloride groups; the weight ratio of the non-grafted impact modifier to the grafted impact modifier is from 1:3 to 3:1, preferably from 2:1 to 1:2, more preferably from 1.5:1 to 1:1.5; and
d) 0-10 wt % of additives; based on the total weight of the polyamide composition.

Specific embodiment 11 is a polyamide composition comprising:
a) 55-85 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 12 carbon atoms;
R² independently equals to or differs from each other, is an alkylene group having from 4 to 18 carbon atoms;
R³ independently equals to or differs from each other, is an alkylene group having from 8 to 20 and 34 carbon atoms;
b) 5-30 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer; the grafted reactive group of the grafted impact modifier is carboxyl, acid anhydride, epoxy, sulphonic acid or acid chloride groups; the weight ratio of the non-grafted impact modifier to the grafted impact modifier is from 1:3 to 3:1, preferably from 2:1 to 1:2, more preferably from 1.5:1 to 1:1.5; and
d) 0-10 wt % of additives; based on the total weight of the polyamide composition.

Specific embodiment 12 is a polyamide composition comprising:
a) 60-80 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
b) 10-25 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer;
d) 0-10 wt % of additives; based on the total weight of the polyamide composition.

Specific embodiment 13 is a polyamide composition comprising:
a) 60-80 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
b) 10-25 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer; the grafted reactive group of the grafted impact modifier is carboxyl, acid anhydride, epoxy, sulphonic acid or acid chloride groups; and
d) 0-10 wt % of additives; based on the total weight of the polyamide composition.

Specific embodiment 14 is a polyamide composition comprising:
a) 60-80 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
b) 10-25 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer; the grafted reactive group of the grafted impact modifier is carboxyl, acid anhydride, epoxy, sulphonic acid or acid chloride groups; the weight ratio of the non-grafted impact modifier to the grafted impact modifier is from 1:3 to 3:1, preferably from 2:1 to 1:2, more preferably from 1.5:1 to 1:1.5; and
d) 0-10 wt % of additives; based on the total weight of the polyamide composition.

Specific embodiment 15 is a polyamide composition comprising:
a) 60-80 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 19 carbon atoms;
R² independently equals to or differs from each other, is an alkylene group having from 4 to 24 carbon atoms;
R³ independently equals to or differs from each other, is an alkylene group having from 8 to 36 carbon atoms;
b) 10-25 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer; and
d) 0-10 wt % of additives; based on the total weight of the polyamide composition.

Specific embodiment 16 is a polyamide composition comprising:
a) 60-80 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 19 carbon atoms;
R² independently equals to or differs from each other, is an alkylene group having from 4 to 24 carbon atoms;
R³ independently equals to or differs from each other, is an alkylene group having from 8 to 36 carbon atoms;
b) 10-25 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer; the grafted reactive group of the grafted impact modifier is carboxyl, acid anhydride, epoxy, sulphonic acid or acid chloride groups; and
d) 0-10 wt % of additives; based on the total weight of the polyamide composition.

Specific embodiment 17 is a polyamide composition comprising:
a) 60-80 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 19 carbon atoms;
R² independently equals to or differs from each other, is an alkylene group having from 4 to 24 carbon atoms;
R³ independently equals to or differs from each other, is an alkylene group having from 8 to 36 carbon atoms;
b) 10-25 wt % of hollow glass bubbles;
c) 3-20 wt % of a combination of grafted impact modifier and non-grafted impact modifier; the non-grafted impact modifier is selected from ethylene-based elastomer and styrene-based elastomer; the grafted impact modifier is selected from grafted ethylene-based elastomer and styrene-based elastomer; the grafted reactive group of the grafted impact modifier is carboxyl, acid anhydride, epoxy, sulphonic acid or acid chloride groups; the weight ratio of the non-grafted impact modifier to the grafted impact modifier is from 1:3 to 3:1, preferably from 2:1 to 1:2, more preferably from 1.5:1 to 1:1.5; and
d) 0-10 wt % of additives; based on the total weight of the polyamide composition.

Specific embodiment 18 is a polyamide composition comprising:
a) 60-80 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 19 carbon atoms;
R² independently equals to or differs from each other, is an alkylene group having from 4 to 24 carbon atoms;
R³ independently equals to or differs from each other, is an alkylene group having from 8 to 36 carbon atoms;
b) 10-25 wt % of hollow glass bubbles;
c) 3-20 wt % of a combination of grafted ethylene-based and/or styrene-based elastomer and non-grafted ethylene-based and/or styrene-based elastomer; the grafted reactive group of the grafted ethylene-based and/or styrene-based elastomer is carboxyl, acid anhydride, or epoxy; the ethylene-based elastomer is selected from the group consisting of ethylene-α-olefin, an elastomer consisting of ethylene-α-olefin-diene, an elastomer consisting of ethylene-unsaturated carboxylic acid, an elastomer consisting of ethylene-unsaturated carboxylic acid ester, an elastomer consisting of ethylene-unsaturated carboxylic acid-unsaturated carboxylic acid ester, an elastomer consisting of ethylene-α-olefin-unsaturated carboxylic acid-unsaturated carboxylic acid ester; the styrene-based elastomer is selected from the group consisting of styrene-isobutylene/styrene-hydrogenated polyolefin, styrene-ethylene-butadiene-styrene copolymer, styrene-butadiene-styrene copolymer; the weight ratio of the non-grafted impact modifier to the grafted impact modifier is from 1:3 to 3:1, preferably from 2:1 to 1:2, more preferably from 1.5:1 to 1:1.5; and
d) 0-10 wt % of additives; based on the total weight of the polyamide composition.

Specific embodiment 19 is a polyamide composition comprising:
a) 60-80 wt % of at least one polyamide selected from a polyamide having a repeating unit of Formula (I), and a polyamide having a repeating unit of Formula (II);

[symbol]

NH—R¹—CO [symbol] Formula (I);

[symbol]

NH—R²—NH—CO—R³—CO [symbol] Formula (II);
R¹ independently equals to or differs from each other, is an alkylene group having from 8 to 12 carbon atoms;
R² independently equals to or differs from each other, is an alkylene group having from 4 to 18 carbon atoms;
R³ independently equals to or differs from each other, is an alkylene group having from 8 to 20 and 34 carbon atoms;
b) 10-25 wt % of hollow glass bubbles;
c) 3-20 wt % of a combination of maleic anhydride grafted ethylene-based and/or styrene-based elastomer, and non-grafted ethylene-based and/or styrene-based elastomer; the ethylene-based elastomer is ethylene-butene copolymer, ethylene-propylene copolymer, ethylene-pentene copolymer, ethylene-isobutene copolymer, and/or ethylene-octene copolymer; the styrene-based elastomer is styrene-ethylene-butadiene-styrene copolymer, styrene-butadiene-styrene copolymer; the weight ratio of the non-grafted impact modifier to the grafted impact modifier is from 1:3 to 3:1, preferably from 2:1 to 1:2, more preferably from 1.5:1 to 1:1.5; and
d) 0-10 wt % of additives; based on the total weight of the polyamide composition.

Specific embodiment 20 is a polyamide composition comprising:
a) 60-80 wt % of at least one polyamide selected from PA9, PA10, PA11, PA12, PA13, PA6,9, PA4, 10, PA5, 10, PA5, 13, PA5, 15, PA6, 10, PA6, 12, PA6, 14, PA6, 18, PA8,8, PA8, 10, PA8, 12, PA10, 10, PA10, 12, PA10, 14, PA10, 18, PA12, 10, PA12, 12, PA12, 14, PA12, 18, PA13, 13, PA14, 10, PA14, 12, PA14, 14, PA14, 18, PA6,36, PA6/PA6,36, PA6,6/PA4, 10, PA6,6/PA6, 10, PA6/PA6, 10, PA6,6/PA6, 12, and/or PA6/PA6, 12;
b) 15-20 wt % of hollow glass bubbles surface treated with epoxide;
c) 3-20 wt % of a combination of maleic anhydride grafted ethylene-based and/or styrene-based elastomer, and non-grafted ethylene-based and/or styrene-based elastomer; the ethylene-based elastomer is ethylene-butene copolymer, ethylene-propylene copolymer, ethylene-pentene copolymer, ethylene-isobutene copolymer, and/or ethylene-octene copolymer; the styrene-based elastomer is styrene-ethylene-butadiene-styrene copolymer, styrene-butadiene-styrene copolymer; the weight ratio of the non-grafted impact modifier to the grafted impact modifier is from 1:3 to 3:1, preferably from 2:1 to 1:2, more preferably from 1.5:1 to 1:1.5; and d) 0-10 wt % of additives; based on the total weight of the polyamide composition.

Specific embodiment 21 is a polyamide composition comprising:
a) 60-80 wt % of at least one polyamide selected from PA9, PA10, PA11, PA12, PA13, PA6,9, PA4, 10, PA5, 10, PA5, 13, PA5, 15, PA6, 10, PA6, 12, PA6, 14, PA6, 18, PA8,8, PA8, 10, PA8, 12, PA10, 10, PA10, 12, PA10, 14, PA10, 18, PA12, 10, PA12, 12, PA12, 14, PA12, 18, PA13, 13, PA14, 10, PA14, 12, PA14, 14, PA14, 18, PA6,36, PA6/PA6,36, PA6,6/PA4, 10, PA6,6/PA6, 10, PA6/PA6, 10, PA6,6/PA6, 12, and/or PA6/PA6, 12;
b) 15-20 wt % of hollow glass bubbles surface treated with epoxide;
c) 3-20 wt % of a combination of maleic anhydride grafted impact modifier and non-grafted impact modifier; the maleic anhydride grafted impact modifier is maleic anhydride grafted ethylene-isobutene copolymer and/or maleic anhydride grafted styrene-ethylene-butadiene-styrene copolymer, the non-grafted impact modifier is ethylene-isobutene copolymer and/or styrene-ethylene-butadiene-styrene copolymer; the weight ratio of the non-grafted impact modifier to the grafted impact modifier is from 1:3 to 3:1, preferably from 2:1 to 1:2, more preferably from 1.5:1 to 1:1.5; and
d) 0.5-5 wt % of additives; based on the total weight of the polyamide composition.

Specific embodiment 22 is a polyamide composition comprising:
a) 60-80 wt % of at least one polyamide selected from PA12, PA5, 10, PA6, 10, PA6, 12, PA10, 10, PA10, 12, PA12, 12, PA6/PA6,36, PA6,6/PA6, 10, PA6/PA6, 10, PA6,6/PA6, 12, and/or PA6/PA6, 12;
b) 15-20 wt % of hollow glass bubbles surface treated with epoxide;
c) 3-20 wt % of a combination of maleic anhydride grafted impact modifier and non-grafted impact modifier; the maleic anhydride grafted impact modifier is maleic anhydride grafted ethylene-isobutene copolymer and/or maleic anhydride grafted styrene-ethylene-butadiene-styrene copolymer, the non-grafted impact modifier is ethylene-isobutene copolymer and/or styrene-ethylene-butadiene-styrene copolymer; the weight ratio of the non-grafted impact modifier to the grafted impact modifier is from 1:3 to 3:1, preferably from 2:1 to 1:2, more preferably from 1.5:1 to 1:1.5; and
d) 0.5-5 wt % of additives; based on the total weight of the polyamide composition.

Specific embodiment 23 is a polyamide composition comprising:
a) 60-80 wt % of at least one polyamide selected from PA6, 12, PA6, 14, PA6, 18, PA8,8, PA8, 10, PA8, 12, PA10, 10, PA10, 12, PA10, 14, PA10, 18, PA12, 10, PA12, 12, PA12, 14, PA12, 18, PA13, 13, PA14, 10, PA14, 12, PA14, 14, PA14, 18, PA6,36, PA6/PA6,36, PA6,6/PA4, 10, PA6,6/PA6, 10, PA6/PA6, 10, PA6,6/PA6, 12, and/or PA6/PA6, 12;
b) 15-20 wt % of hollow glass bubbles surface treated with epoxide;
c) 3-20 wt % of a combination of maleic anhydride grafted styrene-ethylene-butadiene-styrene copolymer and styrene-ethylene-butadiene-styrene copolymer; the weight ratio of styrene-ethylene-butadiene-styrene copolymer to maleic anhydride grafted styrene-ethylene-butadiene-styrene copolymer is from 1:3 to 3:1, preferably from 2:1 to 1:2, more preferably from 1.5:1 to 1:1.5; and
d) 0.5-5 wt % of additives; based on the total weight of the polyamide composition.

Specific embodiment 24 is a polyamide composition comprising:
a) 60-80 wt % of at least one polyamide selected from PA9, PA10, PA11, PA12, PA13, PA6,9, PA4, 10, PA5, 10, PA5, 13, PA5, 15, PA6, 10, PA6, 12, PA6, 14, PA6, 18, PA8,8, PA8, 10, PA8, 12, PA10, 10, PA10, 12, PA10, 14, PA10, 18, PA12, 10, PA12, 12, PA12, 14, PA12, 18, PA13, 13, PA14, 10, PA14, 12, PA14, 14, PA14, 18, PA6,36, PA6/PA6,36, PA6,6/PA4, 10, PA6,6/PA6, 10, PA6/PA6, 10, PA6,6/PA6, 12, and/or PA6/PA6, 12;
b) 15-20 wt % of hollow glass bubbles surface treated with epoxide;
c) 3-20 wt % of a combination of maleic anhydride grafted ethylene-isobutene copolymer and ethylene-isobutene copolymer; the weight ratio of ethylene-isobutene copolymer to maleic anhydride grafted ethylene-isobutene copolymer is from 1:3 to 3:1, preferably from 2:1 to 1:2, more preferably from 1.5:1 to 1:1.5; and
d) 0.5-5 wt % of additives; based on the total weight of the polyamide composition.

Specific embodiment 25 is a polyamide composition comprising:
a) 55-85 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 4 to 6 carbon atoms;
R⁸ independently equals to or differs from each other, is an alkylene group having from 7 to 10 carbon atoms;
R⁹ independently equals to or differs from each other, is an alkylene group having from 10 to 39 carbon atoms;
R¹⁰ independently, equals to or differs from each other, is an alkylene group having from 6 to 40 carbon atoms;
R¹¹ independently, equals to or differs from each other, is an alkylene group having from 8 to 38 carbon atoms;
the total number of carbon atom in Formula (VII) is more than 18;
b) 5-30 wt % of hollow glass bubbles;
c) 3-20 wt % of impact modifier; and
d) 0-10 wt % of additives; based on the total weight of the polyamide composition.

Specific embodiment 26 is a polyamide composition comprising:
a) 55-85 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18;
b) 5-30 wt % of hollow glass bubbles surface treated with epoxide;
c) 3-20 wt % of impact modifier; and
d) 0-10 wt % of additives; based on the total weight of the polyamide composition.

Specific embodiment 27 is a polyamide composition comprising:
a) 60-80 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 4 to 6 carbon atoms;
R⁸ independently equals to or differs from each other, is an alkylene group having from 7 to 10 carbon atoms;
R⁹ independently equals to or differs from each other, is an alkylene group having from 10 to 39 carbon atoms;
R¹⁰ independently, equals to or differs from each other, is an alkylene group having from 6 to 40 carbon atoms;
R¹¹ independently, equals to or differs from each other, is an alkylene group having from 8 to 38 carbon atoms;
the total number of carbon atom in Formula (VII) is more than 18;
b) 10-25 wt % of hollow glass bubbles;
c) 3-20 wt % of impact modifier; and
d) 0-10 wt % of additives; based on the total weight of the polyamide composition.

Specific embodiment 28 is a polyamide composition comprising:
a) 60-80 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18;
b) 10-25 wt % of hollow glass bubbles surface treated with epoxide;
c) 3-20 wt % of impact modifier; and
d) 0-10 wt % of additives; based on the total weight of the polyamide composition.

Specific embodiment 29 is a polyamide composition comprising:
a) 55-85 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18;
b) 5-30 wt % of hollow glass bubbles surface treated with epoxide;
c) 3-20 wt % of impact modifier which is selected from the group of grafted styrene-based, grafted ethylene-based, ethylene-based and styrene-based elastomer; and
d) 0-10 wt % of additives; based on the total weight of the polyamide composition.

Specific embodiment 30 is a polyamide composition comprising:
a) 60-80 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18;
b) 10-25 wt % of hollow glass bubbles surface treated with epoxide;
c) 3-20 wt % of impact modifier which is selected from the group of grafted styrene-based, grafted ethylene-based, ethylene-based and styrene-based elastomer; and
d) 0-10 wt % of additives; based on the total weight of the polyamide composition.

Specific embodiment 31 is a polyamide composition comprising:
a) 55-85 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10, 10, PA10, 12, PA12, 12, PA6,36, PA6,6/PA6,36, and mixture thereof;
b) 5-30 wt % of hollow glass bubbles surface treated with epoxide;
c) 3-20 wt % of impact modifier;
d) 0-10 wt % of additives; based on the total weight of the polyamide composition.

Specific embodiment 32 is a polyamide composition comprising:
a) 55-85 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10, 10, PA10, 12, PA12, 12, PA6,36, PA6,6/PA6,36, and mixture thereof;
b) 5-30 wt % of hollow glass bubbles surface treated with epoxide;
c) 3-20 wt % of impact modifier which is selected from the group of grafted styrene-based, grafted ethylene-based, ethylene-based and styrene-based elastomer; and
d) 0-10 wt % of additives; based on the total weight of the polyamide composition.

Specific embodiment 33 is a polyamide composition comprising:
a) 55-85 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10, 10, PA10, 12, PA12, 12, PA6,36, PA6,6/PA6,36, and mixture thereof;
b) 5-30 wt % of hollow glass bubbles surface treated with epoxide;
c) 3-20 wt % of impact modifier which is grafted styrene-based and/or grafted ethylene-based elastomer; the grafted reactive group of the grafted ethylene-based and/or styrene-based elastomer is carboxyl, acid anhydride, or epoxy; the ethylene-based elastomer is selected from the group consisting of ethylene-α-olefin, an elastomer consisting of ethylene-α-olefin-diene, an elastomer consisting of ethylene-unsaturated carboxylic acid, an elastomer consisting of ethylene-unsaturated carboxylic acid ester, an elastomer consisting of ethylene-unsaturated carboxylic acid-unsaturated carboxylic acid ester, an elastomer consisting of ethylene-α-olefin-unsaturated carboxylic acid-unsaturated carboxylic acid ester; the styrene-based elastomer is selected from the group consisting of styrene-isobutylene/styrene-hydrogenated polyolefin, styrene-ethylene-butadiene-styrene copolymer, styrene-butadiene-styrene copolymer;
d) 0-10 wt % of additives; based on the total weight of the polyamide composition.

Specific embodiment 34 is a polyamide composition comprising:
a) 55-85 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10,10, PA10, 12, PA12, 12, PA6,36, PA6,6/PA6,36, and mixture thereof;
b) 5-30 wt % of hollow glass bubbles surface treated with epoxide;
c) 3-20 wt % of impact modifier which is selected from the group consisting of maleic anhydride grafted, (meth)acrylic anhydride grafted, glycidyl acrylate grafted and glycidyl methacrylate grafted styrene-based elastomer, and maleic anhydride grafted, (meth)acrylic anhydride grafted, glycidyl acrylate grafted and glycidyl methacrylate grafted ethylene-based elastomer; d) 0-10 wt % of additives; based on the total weight of the polyamide composition.

Specific embodiment 35 is a polyamide composition comprising:
a) 55-85 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10, 10, PA10, 12, PA12, 12, PA6,36, PA6,6/PA6,36, and mixture thereof;
b) 5-30 wt % of hollow glass bubbles surface treated with epoxide;
c) 3-20 wt % of impact modifier which is selected from the group consisting of maleic anhydride grafted ethylene-α-olefin, maleic anhydride grafted styrene-isobutylene/styrene-hydrogenated polyolefin, maleic anhydride grafted styrene-ethylene-butadiene-styrene copolymer, maleic anhydride grafted styrene-butadiene-styrene copolymer;
d) 0-10 wt % of additives; based on the total weight of the polyamide composition.

Specific embodiment 36 is a polyamide composition comprising:
a) 55-85 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10, 10, PA10, 12, PA12, 12, PA6,36, PA6,6/PA6,36, and mixture thereof;
b) 5-30 wt % of hollow glass bubbles surface treated with epoxide;
c) 3-20 wt % of impact modifier which is selected from the group consisting of maleic anhydride grafted ethylene-octene copolymer, and/or maleic anhydride grafted styrene-ethylene-butadiene-styrene copolymer;
d) 0-10 wt % of additives; based on the total weight of the polyamide composition.

Specific embodiment 37 is a polyamide composition comprising:
a) 60-80 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10, 10, PA10, 12, PA12, 12, PA6,36, PA6,6/PA6,36, and mixture thereof;
b) 10-25 wt % of hollow glass bubbles surface treated with epoxide;
c) 3-20 wt % of impact modifier which is grafted styrene-based and/or grafted ethylene-based elastomer; the grafted reactive group of the grafted ethylene-based and/or styrene-based elastomer is carboxyl, acid anhydride, or epoxy; the ethylene-based elastomer is selected from the group consisting of ethylene-α-olefin, an elastomer consisting of ethylene-α-olefin-diene, an elastomer consisting of ethylene-unsaturated carboxylic acid, an elastomer consisting of ethylene-unsaturated carboxylic acid ester, an elastomer consisting of ethylene-unsaturated carboxylic acid-unsaturated carboxylic acid ester, an elastomer consisting of ethylene-α-olefin-unsaturated carboxylic acid-unsaturated carboxylic acid ester; the styrene-based elastomer is selected from the group consisting of styrene-isobutylene/styrene-hydrogenated polyolefin, styrene-ethylene-butadiene-styrene copolymer, styrene-butadiene-styrene copolymer;
d) 0-10 wt % of additives; based on the total weight of the polyamide composition.

Specific embodiment 38 is a polyamide composition comprising:
a) 60-80 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10, 10, PA10, 12, PA12, 12, PA6,36, PA6,6/PA6,36, and mixture thereof;
b) 10-25 wt % of hollow glass bubbles surface treated with epoxide;
c) 3-20 wt % of impact modifier which is selected from the group consisting of maleic anhydride grafted, (meth)acrylic anhydride grafted, glycidyl acrylate grafted and glycidyl methacrylate grafted styrene-based elastomer, and maleic anhydride grafted, (meth)acrylic anhydride grafted, glycidyl acrylate grafted and glycidyl methacrylate grafted ethylene-based elastomer;
d) 0-10 wt % of additives; based on the total weight of the polyamide composition.

Specific embodiment 39 is a polyamide composition comprising:
a) 60-80 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10,10, PA10, 12, PA12, 12, PA6,36, PA6,6/PA6,36, and mixture thereof;
b) 10-25 wt % of hollow glass bubbles surface treated with epoxide;
c) 3-20 wt % of impact modifier which is selected from the group consisting of maleic anhydride grafted ethylene-α-olefin, maleic anhydride grafted styrene-isobutylene/styrene-hydrogenated polyolefin, maleic anhydride grafted styrene-ethylene-butadiene-styrene copolymer, maleic anhydride grafted styrene-butadiene-styrene copolymer;
d) 0-10 wt % of additives; based on the total weight of the polyamide composition.

Specific embodiment 40 is a polyamide composition comprising:
a) 60-80 wt % of a combination of at least two polyamides, one polyamide is selected from the group consisting of PA4, 10, PA5, 10, PA6, 10, PA6,9, PA6, 12, PA6,6/PA4, 10, PA6,6/PA6, 10, PA6/PA6, 10, PA6,6/PA6, 12, PA6/PA6, 12, and mixture thereof; the other polyamide is selected from the group consisting of PA11, PA12, PA13, PA10, 10, PA10, 12, PA12, 12, PA6,36, PA6,6/PA6,36, and mixture thereof;
b) 10-25 wt % of hollow glass bubbles surface treated with epoxide;
c) 3-20 wt % of impact modifier which is selected from the group consisting of maleic anhydride grafted ethylene-octene copolymer, and/or maleic anhydride grafted styrene-ethylene-butadiene-styrene copolymer;
d) 0.5-5 wt % of additives; based on the total weight of the polyamide composition.

Specific embodiment 41 is a polyamide composition comprising:
a) 55-85 wt % of a combination of at least two polyamides, one polyamide is selected from the group consisting of PA5, 10, PA6, 10, PA6, 12, PA6,6/PA6, 10, PA6/PA6, 10, PA6,6/PA6, 12, PA6/PA6, 12, and mixture thereof; the other polyamide is selected from the group consisting of PA10, 10, PA10, 12, PA12, 12, PA6,36, PA6,6/PA6,36, and mixture thereof;
b) 5-30 wt % of hollow glass bubbles surface treated with epoxide;
c) 3-20 wt % of impact modifier which is selected from the group consisting of maleic anhydride grafted ethylene-octene copolymer, and/or maleic anhydride grafted styrene-ethylene-butadiene-styrene copolymer;
d) 0.5-5 wt % of additives; based on the total weight of the polyamide composition.

Specific embodiment 42 is a polyamide composition comprising:
a) 55-85 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18;
b) 5-30 wt % of hollow glass bubbles surface treated with epoxide;
c) 3-20 wt % of impact modifier which is the combination of grafted impact modifier and non-grafted impact modifier; and
d) 0-10 wt % of additives; based on the total weight of the polyamide composition.

Specific embodiment 43 is a polyamide composition comprising:
a) 55-85 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18;
b) 5-30 wt % of hollow glass bubbles surface treated with epoxide;
c) 3-20 wt % of impact modifier which is the combination of grafted impact modifier and non-grafted impact modifier; the non-grafted impact modifier is ethylene-based and/or styrene-based elastomers, the grafted impact modifier is acid anhydride grafted ethylene-based elastomer, acid anhydride grafted styrene-based elastomer, glycidyl methacrylate grafted ethylene-based elastomer, glycidyl methacrylate grafted styrene-based elastomer; and
d) 0-10 wt % of additives; based on the total weight of the polyamide composition.

Specific embodiment 44 is a polyamide composition comprising:
a) 55-85 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18;
b) 5-30 wt % of hollow glass bubbles surface treated with epoxide;
c) 3-20 wt % of impact modifier which is the combination of grafted impact modifier and non-grafted impact modifier; the non-grafted impact modifier is ethylene-octene copolymer and/or SEBS, the grafted impact modifier is maleic anhydride grafted ethylene-octene elastomer, maleic anhydride grafted SEBS, glycidyl methacrylate grafted ethylene-octene elastomer, glycidyl methacrylate grafted SEBS elastomer; the weight ratio of grafted impact modifier to non-grafted impact modifier is from 3:1 to 1:3, preferably from 2:1 to 1:2, more preferably from 1:1.5 to 1.5 to 1; and
d) 0-10 wt % of additives; based on the total weight of the polyamide composition.

Specific embodiment 45 is a polyamide composition comprising:
a) 55-85 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 4 or 6 carbon atoms;
R⁸ independently equals to or differs from each other, is an alkylene group having from 7 to 10 carbon atoms;
R⁹ independently equals to or differs from each other, is an alkylene group having from 10 to 39 carbon atoms;
R¹⁰ independently, equals to or differs from each other, is an alkylene group having from 6 to 40 carbon atoms;
R¹¹ independently, equals to or differs from each other, is an alkylene group having from 8 to 38 carbon atoms;
the total number of carbon atom in Formula (VII) is more than 18; the weight ratio of the polyamide having a repeating unit of Formula (V) to the polyamide having a repeating unit of Formula (VI) or Formula (VII) is 2:1 to 4:1;
b) 5-30 wt % of hollow glass bubbles surface treated with epoxide;
c) 3-20 wt % of impact modifier; and
d) 0-10 wt % of additives; based on the total weight of the polyamide composition.

Specific embodiment 46 is a polyamide composition comprising:
a) 60-80 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 4 to 6 carbon atoms;
R⁸ independently equals to or differs from each other, is an alkylene group having from 7 to 10 carbon atoms;
R⁹ independently equals to or differs from each other, is an alkylene group having from 10 to 39 carbon atoms;
R¹⁰ independently, equals to or differs from each other, is an alkylene group having from 6 to 40 carbon atoms;
R¹¹ independently, equals to or differs from each other, is an alkylene group having from 8 to 38 carbon atoms;
the total number of carbon atom in Formula (VII) is more than 18; the weight ratio of the polyamide having a repeating unit of Formula (V) to the polyamide having a repeating unit of Formula (VI) or Formula (VII) is 2:1 to 4:1;
b) 10-25 wt % of hollow glass bubbles;
c) 3-20 wt % of impact modifier; and
d) 0-10 wt % of additives; based on the total weight of the polyamide composition.

Specific embodiment 47 is a polyamide composition comprising:
a) 60-80 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18; the weight ratio of the polyamide having a repeating unit of Formula (V) to the polyamide having a repeating unit of Formula (VI) or Formula (VII) is 2:1 to 4:1;
b) 10-25 wt % of hollow glass bubbles surface treated with epoxide;
c) 3-20 wt % of impact modifier; and
d) 0-10 wt % of additives; based on the total weight of the polyamide composition.

Specific embodiment 48 is a polyamide composition comprising:
a) 55-85 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18; the weight ratio of the polyamide having a repeating unit of Formula (V) to the polyamide having a repeating unit of Formula (VI) or Formula (VII) is 2:1 to 4:1;
b) 5-30 wt % of hollow glass bubbles surface treated with epoxide;
c) 3-20 wt % of impact modifier which is selected from the group of grafted styrene-based, grafted ethylene-based, ethylene-based and styrene-based elastomer; and
d) 0-10 wt % of additives; based on the total weight of the polyamide composition.

Specific embodiment 49 is a polyamide composition comprising:
a) 60-80 wt % of a combination of at least two polyamides, one of the at least two polyamides has a repeating unit of Formula (V), the other one of the at least two polyamides has a repeating unit of Formula (VI) or of Formula (VII):

[symbol]

NH—R⁷—NH—CO—R⁸—CO [symbol] Formula (V);

[symbol]

NH—R—CO [symbol] Formula (VI);

[symbol]

NH—R¹⁰—NH—CO—R¹¹—CO [symbol] Formula (VII);
R⁷ independently equals to or differs from each other, is an alkylene group having from 5 or 6 carbon atoms;
R⁸ independently equals to or differs from each other, is an alkylene group having from 8 to 10 carbon atoms;
R⁹ independently equals to or differs from each other, is an alkylene group having from 10 to 24 carbon atoms;
R¹⁰ independently, equals to or differs from each other, is an alkylene group having from 6 to 24 carbon atoms;
R¹¹ independently, equals to or differs from each other, is an alkylene group having from 8 to 20 and 34 carbon atoms;
the total number of carbon atom in Formula (VII) is more than 18; the weight ratio of the polyamide having a repeating unit of Formula (V) to the polyamide having a repeating unit of Formula (VI) or Formula (VII) is 2:1 to 4:1;
b) 10-25 wt % of hollow glass bubbles surface treated with epoxide;
c) 3-20 wt % of impact modifier which is selected from the group of grafted styrene-based, grafted ethylene-based, ethylene-based and styrene-based elastomer; and the weight ratio of grafted impact modifier to non-grafted impact modifier is from 3:1 to 1:3, preferably from 2:1 to 1:2, more preferably from 1:1.5 to 1.5 to 1; and
d) 0-10 wt % of additives; based on the total weight of the polyamide composition.

### Examples

The following non-limiting examples illustrate various features and characteristics of the present invention, the scope of the present invention should not be construed as limited thereto:

The formulations for the examples and comparative examples are shown in the following Tables 1 and 2 and the specific components used therein are:

### Polyamide

PA6,10: Type II, from Shangdong Dongchen New Technology Co. Ltd.
PA6,6: Ultramid A27E, from BASF SE
PA6/6.36: Ultramid F29, from BASF SE
PA12,12: Shangdong Dongchen New Technology Co. Ltd.
PA10,12: Shangdong Dongchen New Technology Co. Ltd.
PA9 T: GC51010 from Kuraray

### Hollow Glass Bubbles

iM 16K treated: epoxy modified iM 16K, from 3M

### Non-Grafted Impact Modifier

Kraton G1657: SEBS (styrene: rubber=13/87), from Kraton

### Grafted Impact Modifier

Kraton FG1901: SEBS-g-MAH (styrene: rubber=30/70), graft ratio=1.7 wt %, from Kraton
Kraton FG 1924: SEBS-g-MAH (styrene: rubber=13/87), graft ratio=1 wt %, from Kraton
Fusabond N493: POE-g-MAH, graft ratio=0.5 wt %, from Dupont
Tafmer MH5020C: POE-g-MAH, graft ratio=0.67 wt %, from Mitsui

### Impact Modifier

Kumho HR181: ABS, Kumho petrochemical.

### Glass Fiber

NEG 3610: Glass fiber ChopVantage HP 3610, from Nippon Electric Glass

### Antioxidant

Irganox 1098: from BASF SE
EBS: lubricant, from SINWON chemical CO., Ltd
UB624: colorant, from BASF SE

The extruding condition for the following examples is:

The raw materials except hollow glass bubbles are mixed together in a Turbula T50A highspeed stirrer, fed into a Coperion ZSK26MC twin-screw extruder, the glass bubbles are fed at a downstream side feeder; melt-extruded under a temperature of 270° C., pelletized, thus obtaining a polyamide composition in a pellet form.

After drying the obtained pellets at 100° C. for 6 hours, the dried pellets were processed in an injection molding machine KM130CX, from Krauss Maffei with a clamping force of 130 T at melt temperatures of 250° C. to 280° C. to give test specimens.

All the components of the polyamide compositions of examples E1-E10 and comparative examples CE1-CE12 are respectively listed in Tables 1 and 2. The mechanical properties are tested based on the methods as below:

### For Spiral Flow

Material's melt flow is also measured by spiral flow test for providing an indicator of actual injection molding flow performance. A mold having a spiral flow channel emanating from the center with a depth of 2 mm, width of 5 mm and length of 115 cm is used for the test. The longest distance between any two points of the outermost wall of the channel is 15.0 cm and the shortest distance between any two points of the outermost wall of the channel is 3.7 cm. The channel has notches etched every 1 centimeter, which are numbered every five centimeters for identifying the distance from the center. The melt to be tested is injected at 270° C. and 500 bar from a sprue at the center of the spiral and flows along the channel of the mold maintained at a temperature of 80° C. The melt flow distance until the flow stops is recorded. The longer the flow distance, the better the melt flow performance for injection molding.
Density: ISO 1183
Tensile stress at break, tensile modulus, tensile strain at break: ISO 527, using specimens having size of 171 mm*10 mm*4 mm (length*width*thickness)
Flexural modulus: ISO 178
Charpy unnotched impact strength: ISO 179 using specimens having size of 80 mm*10 mm*4 mm (length*width*thickness)

TABLE 1

| | Component | E1 | E2 | E3 | E4 | E5 | E6 | E7 | E8 | E9 | E10 |
|---|---|---|---|---|---|---|---|---|---|---|---|
| Polyamide | PA6, 10 | 59.63 | 73.3 | | | 56.63 | 54.63 | 44.63 | 63.3 | 59.63 | 59.63 |
| | PA10, 12 | 15 | | | | 15 | 15 | 20 | | 15 | 15 |
| | PA9T | | | | | | | | | | |
| | PA6/6.36 | | | 73.3 | | | | | | | |
| | PA12, 12 | | | | 73.3 | | | | | | |
| | PA66 | | | | | | | | | | |
| Non-grafted impact | Kraton G1657 | 2.5 | 2.5 | 2.5 | 2.5 | 4 | 5 | 6 | 7.5 | | |
| modifier | | | | | | | | | | | |
| Grafted impact | Kraton FG1901 | 2.5 | 2.5 | 2.5 | 2.5 | 4 | 5 | 6 | 7.5 | | |
| modifier | Fusabond N493 | | | | | | | | | 5 | |
| | Tafmer | | | | | | | | | | 5 |
| | MH5020C | | | | | | | | | | |
| Impact modifier | Kumho HR181 | | | | | | | | | | |
| Hollow glass | iM16K treated | 19 | 20 | 20 | 20 | 19 | 19 | 22 | 20 | 19 | 19 |
| bubbles | | | | | | | | | | | |
| Glass fiber | NEG 3610 | | | | | | | | | | |
| Antioxidant | Irganox 1098 | 0.2 | 0.2 | 0.2 | 0.2 | 0.2 | 0.2 | 0.2 | 0.2 | 0.2 | 0.2 |
| | EBS | 0.5 | 0.5 | 0.5 | 0.5 | 0.5 | 0.5 | 0.5 | 0.5 | 0.5 | 0.5 |
| | UB624 | 0.67 | 1 | 1 | 1 | 0.67 | 0.67 | 0.67 | 1 | 0.67 | 0.67 |
| Spiral flow | cm | | 42 | 35 | 46 | | | | 39 | | |
| Density | g/cm³ | 0.889 | 0.89 | 0.886 | 0.856 | 0.88 | 0.877 | 0.841 | 0.89 | 0.886 | 0.885 |
| Tensile stress at | MPa | 55.5 | 56.8 | 39 | 42.8 | 50.8 | 48.2 | 44.3 | 45.1 | 52.4 | 53.1 |
| break | | | | | | | | | | | |
| Tensile modulus | MPa | 2720 | 2900 | 2220 | 1930 | 2550 | 2440 | 2330 | 2370 | 2670 | 2670 |
| Tensile strain at | % | 20 | 15 | 18 | 25 | 28 | 29 | 23 | 26 | 21 | 24 |
| break | | | | | | | | | | | |
| Flexural modulus | MPa | 2310 | 2740 | 2300 | 1990 | 2130 | 2010 | 2010 | 2210 | 2200 | 2270 |
| Charpy unnotched | KJ/m² | 140 | 103 | 113 | 132 | 130 | 132 | 131 | 146 | 122 | 114 |
| impact strength | | | | | | | | | | | |

TABLE 2

| | Component | CE1 | CE2 | CE3 | CE4 | CE5 | CE6 | CE7 |
|---|---|---|---|---|---|---|---|---|
| Polyamide | PA6, 10 | 60.8 | 73.3 | 73.3 | 73.3 | 73.3 | 73.3 | 93.3 |
| | PA10, 12 | 10 | | | | | | |
| | PA9T | | | | | | | |
| | PA6/6.36 | | | | | | | |
| | PA12, 12 | | | | | | | |
| | PA66 | | | | | | | |
| Non-grafted impact modifier | Kraton G1657 | 1.25 | | 5 | | | | 2.5 |
| Grafted impact modifier | Kraton FG1901 | 1.25 | 5 | | | | | 2.5 |
| | Fusabond N493 | | | | 5 | | | |
| | Kumho HR181 | | | | | 5 | | |
| Hollow glass bubbles | iM16K treated | 25 | 20 | 20 | 20 | 20 | 25 | |
| Glass fiber | NEG 3610 | | | | | | | |
| Antioxidant | Irganox 1098 | 0.2 | 0.2 | 0.2 | 0.2 | 0.2 | 0.2 | 0.2 |
| | EBS | 0.5 | 0.5 | 0.5 | 0.5 | 0.5 | 0.5 | 0.5 |
| | UB624 | 1 | 1 | 1 | 1 | 1 | 1 | 1 |
| Spiral flow | cm | 44 | 41 | 45 | 42 | 44 | 44 | 50 |
| Density | g/cm³ | 0.849 | 0.9 | 0.89 | 0.905 | 0.914 | 0.855 | 1.071 |
| Tensile stress at break | MPa | 58.3 | 58.3 | 57.4 | 56.6 | 58.9 | 67.2 | 44.8 |
| Tensile modulus | MPa | 3010 | 2940 | 2910 | 2880 | 2920 | 3310 | 2380 |
| Tensile strain at break | % | 13 | 13 | 12 | 12 | 10.13 | 6.7 | 20.7 |
| Flexural modulus | MPa | 2570 | 2740 | 2770 | 2700 | 2790 | 2880 | 2130 |
| Charpy unnotched impact | KJ/m² | 86 | 119 | 96 | 113 | 69 | 46 | N |
| strength | | | | | | | | |

| | Component | CE8 | CE9 | CE10 | CE11 | CE12 |
|---|---|---|---|---|---|---|
| Polyamide | PA6, 10 | 58.3 | 78.3 | 78.3 | | |
| | PA10, 12 | | | 15 | | |
| | PA9T | | | | | 73.3 |
| | PA6/6.36 | | | | | |
| | PA12, 12 | | | | | |
| | PA66 | | | | 73.3 | |
| Non-grafted impact modifier | Kraton G1657 | 2.5 | | | | |
| Grafted impact modifier | Kraton FG1901 | 2.5 | | | | |
| | Fusabond N493 | | | 5 | | |
| | Kumho HR181 | | | | 5 | 5 |
| Hollow glass bubbles | iM16K treated | 35 | 20 | | 20 | 20 |
| Glass fiber | NEG 3610 | | | 20 | | |
| Antioxidant | Irganox 1098 | 0.2 | 0.2 | 0.2 | 0.2 | 0.2 |
| | EBS | 0.5 | 0.5 | 0.5 | 0.5 | 0.5 |
| | UB624 | 1 | 1 | 1 | 1 | 1 |
| Spiral flow | cm | * | 45 | 50 | | |
| Density | g/cm³ | | 0.905 | 1.226 | 0.922 | 0.977 |
| Tensile stress at break | MPa | | 63.7 | 138 | 69.7 | 33.4 |
| Tensile modulus | MPa | | 3070 | 6620 | 3560 | 3250 |
| Tensile strain at break | % | | 10 | 3.9 | 3.3 | 1.1 |
| Flexural modulus | MPa | | 2950 | 6050 | 3580 | 3250 |
| Charpy unnotched impact | KJ/m² | | 33 | 86 | 35 | 12 |
| strength | | | | | | |

* CE8 can't obtain pellets because hollow glass bubbles failed to be fed during extrusion.

Regarding the technical solution including a combination of grafted impact modifier and non-grafted impact modifier, as seen from E1-E8, said combination, when used together with the polyamide and hollow glass bubbles, attributes to obtain compositions of E1-E8 having density less than 0.9 g/cm³, tensile strain at break higher than 15% and other mechanical properties acceptable.

Specifically by comparing E2 with CE2-CE5, the only difference consists in the impact modifier, E2 achieves higher tensile strain at break than CE2-CE5, which proves that a combination of non-grafted impact modifier and grated impact modifier adopted in E2 contributes to the improved toughness of the material, and at the same time, other mechanical properties of E2 are comparable with CE2-CE5. Moreover, although the same amount of hollow glass bubbles was used in E2 and CE2-CE5, E2 achieves a lower density than CE2, CE4 and CE5, which also demonstrates that the selection of impact modifier has contributory effects to lowered density.

As for CE7, though the combination of impact modifier was adopted to obtain a high tensile strain at break, because no hollow glass bubbles were added, the resulting density of the material is 1.071 g/cm³, which is not acceptable for the intended use of the resulting material. On the contrary, the hollow glass bubbles were used in an excess amount in CE8, which renders the raw materials unable to be fed during compounding.

Regarding the technical solution including a specific combination of PA 6, 10 and PA 10, 12, as seen from E1, E5-E7 and E9-E10, said combination, when used together with hollow glass bubbles and impact modifier, attributes to obtain compositions having density less than 0.9 g/cm³, tensile strain at break higher than 20% and acceptable other mechanical properties.

As seen from E9-E10, even though no specific combination of impact modifier was adopted in E9-E10, both of the examples achieve an increased tensile strain at break, which clearly shows that the specific combination of PA6, 10 and PA10, 12 can also attribute to an improved toughness, with other mechanical properties acceptable.

By comparing E9 with CE4, on the condition that the impact modifier adopted therein was the same, it is evident that the combination of PA6, 10 and PA10, 12 in E9 contributes to a better tensile strain at break than that of CE4 which only adopted PA6, 10, while other mechanical properties being acceptable.

1. A polyamide composition comprising at least one polyamide, hollow glass bubbles, and impact modifier,
characterized in that the impact modifier includes a combination of grafted impact modifier and non-grafted impact modifier, and
the at least one polyamide is selected from the group consisting of a polyamide having a repeating unit of Formula (I), and a polyamide having a repeating unit of Formula (II),
[NH—R¹—CO] Formula (I);
[NH—R²—NH—CO—R³—CO] Formula (II);
wherein:
each R¹ is independently identical or different and is a divalent hydrocarbon group having from 8 to 40 carbon atoms;
each R² is independently identical or different and is a divalent hydrocarbon group having from 4 to 40 carbon atoms;
each R³ is independently identical or different and is a divalent hydrocarbon group having from 7 to 38 carbon atoms.

2. The polyamide composition according to claim 1, wherein the at least one polyamide is selected from the group consisting of PA9, PA10, PA11, PA12, PA13, PA6,9, PA4,10, PA5,10, PA5,13, PA5,15, PA6,10, PA6,12, PA6,14, PA6,18, PA8,8, PA8,10, PA8,12, PA10,10, PA10,12, PA10,14, PA10,18, PA12,10, PA12,12, PA12,14, PA12,18, PA13,13, PA14,10, PA14,12, PA14,14, PA14,18, PA6,36, PA6/PA6,36, PA6,6/PA4,10, PA6,6/PA6,10, PA6/PA6,10, PA6,6/PA6,12, and PA6/PA6,12.

3. A polyamide composition comprising a combination of at least two polyamides, hollow glass bubbles, and impact modifier,
characterized in that one of the at least two polyamides has a repeating unit of Formula (V), the other one of the at least two polyamides has a repeating unit of Formula (VI) or of Formula (VII):
[NH—R⁷—NH—CO—R⁸—CO] Formula (V);
[NH—R—CO] Formula (VI);
[NH—R¹⁰—NH—CO—R¹¹—CO] Formula (VII);
wherein:
each R⁷ is independently identical or different and is a divalent hydrocarbon group having from 4 to 6 carbon atoms;
each R⁸ is independently identical or different and is a divalent hydrocarbon group having from 7 to 10 carbon atoms;
each R⁹ is independently identical or different and is a divalent hydrocarbon group having from 10 to 39 carbon atoms;
each R¹⁰ is independently identical or different and independently, equals to or differs from each other, is a divalent hydrocarbon group having from 6 to 40 carbon atoms;
each R¹¹ is independently identical or different and is a divalent hydrocarbon group having from 8 to 38 carbon atoms; and
the total number of carbon atom in Formula (VII) is more than 18.

4. The polyamide composition according to claim 3, wherein the polyamide having a repeating unit of Formula (V) is selected from the group consisting of PA4,10, PA5,10, PA6,10, PA6,9, PA6,12, PA6,6/PA4,10, PA6,6/PA6, 10, PA6/PA6,10, PA6,6/PA6,12, PA6/PA6, 12, and mixtures thereof; and
the polyamide having a repeating unit of Formula (VI) or Formula (VII) is selected from the group consisting of PA11, PA12, PA13, PA10,10, PA10,12, PA12,12, PA6,36, PA6,6/PA6,36, and mixtures thereof.

5. The polyamide composition according to claim 3, wherein the polyamide having a repeating unit of Formula (V) and the polyamide having a repeating unit of Formula (VI) or Formula (VII) are in a weight ratio of from 1.5:1 to 4.5:1.

6. The polyamide composition according to claim 1, wherein the polyamide is in the amount of 55-85 wt %, based on the total weight of the polyamide composition.

7. The polyamide composition according to claim 1, wherein the hollow glass bubbles have a 10 volume % isostatic collapse strength of 8000 PSI or higher; a median diameter from 10 μm to 70 μm; and a true density of 0.9 g/cm³ or less.

8. The polyamide composition according to claim 1, wherein the hollow glass bubbles are surface treated with a coupling agent selected from the group consisting of zirconate, silane, or titanate, urethane, and epoxide.

9. The polyamide composition according to claim 1, wherein the hollow glass bubbles is in the amount of 5-30 wt %, based on the total weight of the polyamide composition.

10. The polyamide composition according to claim 1, wherein the impact modifier is selected from the group consisting of ethylene-based elastomers and styrene-based elastomers.

11. The polyamide composition according to claim 1, wherein the ethylene-based elastomers are selected from the group consisting of an elastomer consisting of ethylene-α-olefin, an elastomer consisting of ethylene-α-olefin-diene, an elastomer consisting of ethylene-unsaturated carboxylic acid, an elastomer consisting of ethylene-unsaturated carboxylic acid ester, an elastomer consisting of ethylene-unsaturated carboxylic acid-unsaturated carboxylic acid ester, and an elastomer consisting of ethylene-α-olefin-unsaturated carboxylic acid-unsaturated carboxylic acid ester, and/or the styrene-based elastomers are selected from the group consisting of styrene-isobutylene/styrene-hydrogenated-polyolefin, styrene-ethylene-butadiene-styrene copolymer, and styrene-butadiene-styrene copolymer.

12. The polyamide composition according to claim 1, wherein the grafted impact modifier is grafted with reactive groups selected from the group consisting of carboxyl, acid anhydride, epoxy, sulphonic acid and acid chloride groups.

13. The polyamide composition according to claim 1, wherein the impact modifier is in the amount of 3-20 wt %, based on the total weight of the polyamide composition.

14. The polyamide composition according to claim 1, wherein the impact modifier includes a combination of styrene-ethylene-butadiene-styrene copolymer and maleic anhydride grafted styrene-ethylene-butadiene-styrene copolymer, or a combination of ethylene-octene copolymer and maleic anhydride grafted ethylene-octene polymer.

15. The polyamide composition according to claim 1, wherein the weight ratio of the non-grafted impact modifier to the grafted impact modifier is in the range from 1:3 to 3:1.

16. A manufacturing process to produce the polyamide composition according to claim 1, comprising combining all components of the polyamide composition.

17. A lightweight part comprising the polyamide composition according to claim 1.

18. An article prepared from the polyamide composition according to claim 1.

19. The lightweight part according the claim 20, wherein the mobile electronic device is selected from the group consisting of a tablet computer, a laptop computer, a pocket calculator, portable media player, mobile internet device, handheld PC, handheld game console, digital media player, mobile phones, a phablet, wearable computers, a head-mounted display, a virtual reality headsets, a digital camera, a global positioning system receiver, a portable power source, a portable Wi-Fi, a portable media player, a pocket calculator, an e-book reader, and combinations thereof; and the automobile component is selected from the group consisting of hoods, trunks, bumpers, grilles, side claddings, rocker panels, fenders, tail-gates, in wire and cable applications, instrument panels, consoles, interior trim, exterior trim, door panels, heater housings, battery supports, headlight housings, front ends, ventilator wheels, reservoirs, soft pads, and combinations thereof.

20. The lightweight part according the claim 18, wherein the lightweight part is for an automobile component or a mobile electronic device.
